(19) United States
(12) Patent Application Publication
(10) Pub. No.: US 2026/0238289 A1
(43) Pub. Date: Aug. 13, 2026

(54) CHANNEL COVARIANCE INFORMATION FOR MODE ADAPTATION

(71) Applicant: QUALCOMM Incorporated, San Diego, CA (US)

(72) Inventors: Narayan PRASAD, Westfield, NJ (US); Wooseok NAM, San Diego, CA (US); Tao LUO, San Diego, CA (US); Sony AKKARAKARAN, Poway, CA (US); Junyi LI, Greentown, PA (US)

(21) Appl. No.: 19/443,485

(22) Filed: Jan. 8, 2026

Related U.S. Application Data
(60) Provisional application No. 63/756,525, filed on Feb. 10, 2025.

(51) Int. Cl. H04B 7/06; H04L 25/02

(52) U.S. Cl. CPC H04B 7/0626; H04B 7/06968; H04L 25/0248

(57) ABSTRACT

Various aspects of the present disclosure generally relate to wireless communication. In some aspects, a user equipment (UE) may receive channel covariance information associated with a channel between a network node and the UE. The UE may transmit, to the network node, a channel state information report based at least in part on the channel covariance information. Numerous other aspects are described.

### CROSS-REFERENCE TO RELATED APPLICATION

This patent application claims priority to U.S. Provisional Patent Application No. 63/756,525 filed on Feb. 10, 2025, entitled “CHANNEL COVARIANCE INFORMATION FOR MODE ADAPTATION,” and assigned to the assignee hereof. The disclosure of the prior Application is considered part of and is incorporated by reference into this patent application.

### FIELD OF THE DISCLOSURE

Aspects of the present disclosure generally relate to wireless communication and specifically relate to techniques, apparatuses, and methods associated with channel covariance information for mode adaptation.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include a transceiver and a processing system. The processing system may include one or more processors and one or more code-storing memories coupled with the one or more processors. The processing system may be configured to receive, via the transceiver, channel covariance information associated with a channel between a network node and the UE. The processing system may be configured to transmit, to the network node via the transceiver, a channel state information (CSI) report based at least in part on the channel covariance information.

Some aspects described herein relate to a network node for wireless communication. The network node may include a transceiver and a processing system. The processing system may include one or more processors and one or more code-storing memories coupled with the one or more processors. The processing system may be configured to transmit, to a UE via the transceiver, channel covariance information associated with a channel between the network node and the UE. The processing system may be configured to receive, from the UE via the transceiver, a CSI report based at least in part on the channel covariance information.

Some aspects described herein relate to a method of wireless communication performed by a UE. The method may include receiving channel covariance information associated with a channel between a network node and the UE. The method may include transmitting, to the network node, a CSI report based at least in part on the channel covariance information.

Some aspects described herein relate to a method of wireless communication performed by a network node. The method may include transmitting, to a UE, channel covariance information associated with a channel between the network node and the UE. The method may include receiving, from the UE, a CSI report based at least in part on the channel covariance information.

Some aspects described herein relate to a non-transitory computer-readable medium that stores a set of instructions for wireless communication by a UE. The set of instructions, when executed by one or more processors of the UE, may cause the UE to receive channel covariance information associated with a channel between a network node and the UE. The set of instructions, when executed by one or more processors of the UE, may cause the UE to transmit, to the network node, a CSI report based at least in part on the channel covariance information.

Some aspects described herein relate to a non-transitory computer-readable medium that stores a set of instructions for wireless communication by a network node. The set of instructions, when executed by one or more processors of the network node, may cause the network node to transmit, to a UE, channel covariance information associated with a channel between the network node and the UE. The set of instructions, when executed by one or more processors of the network node, may cause the network node to receive, from the UE, a CSI report based at least in part on the channel covariance information.

Some aspects described herein relate to an apparatus for wireless communication. The apparatus may include means for receiving channel covariance information associated with a channel between a network node and the apparatus. The apparatus may include means for transmitting, to the network node, a CSI report based at least in part on the channel covariance information.

Some aspects described herein relate to an apparatus for wireless communication. The apparatus may include means for transmitting, to a UE, channel covariance information associated with a channel between the apparatus and the UE. The apparatus may include means for receiving, from the UE, a CSI report based at least in part on the channel covariance information.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of a downlink channel and an example of an uplink channel.

FIG. 4 is a diagram illustrating an example associated with channel covariance information for mode adaptation, in accordance with the present disclosure.

FIG. 5 is a diagram illustrating an example associated with channel covariance information for mode adaptation, in accordance with the present disclosure.

FIG. 6 is a diagram illustrating an example process performed, for example, at a user equipment (UE) or an apparatus of a UE.

FIG. 7 is a diagram illustrating an example process performed, for example, at a network node or an apparatus of a network node.

FIG. 8 is a diagram of an example apparatus for wireless communication.

FIG. 9 is a diagram of an example apparatus for wireless communication.

### DETAILED DESCRIPTION

A device in a wireless communication network, such as a user equipment (UE) or a network node, may perform channel estimation to estimate a channel matrix representing a channel between the device and another device. The channel matrix provides a representation of how a signal propagates from a transmitter device to a receiver device. In some examples, the transmitter device may transmit a signal (e.g., a reference signal), and the receiver device may perform measurements of the signal and estimate the channel (e.g., the channel matrix) between the transmitter device and the received device based on the measurements of the signal. For example, a UE may perform channel measurements and estimate channel state information (CSI) that characterizes a downlink channel between a network node and the UE based on one or more CSI reference signals (CSI-RSs) transmitted by the network node. The UE may then transmit, to the network node, a CSI report that includes CSI. The network node may determine the current downlink channel conditions between the network node and the UE based on the CSI received from the UE, and the network node may adapt transmissions of downlink communications to the UE to the current channel conditions.

In some examples, such as in the case of downlink multiple-input multiple-output (DL-MIMO) communications, the CSI acquisition may result in a high computational burden and a long acquisition time for the UE. Furthermore, some UEs may include flexible radio frequency (RF) architecture with different modes for transmitting or receiving, and the CSI acquisition and reporting used for channel estimation for DL-MIMO communications provides limited support for such flexible architectures. Additionally, the CSI acquisition and reporting used for channel estimation for DL-MIMO communications only supports instantaneous CSI estimation, and does not support CSI prediction by the UE. In some examples in which downlink and uplink communications between a network node and a UE are configured on the same frequency band (e.g., in time division duplex (TDD) systems), there may be reciprocity between the downlink channel and an uplink channel between the UE and the network node. In such examples, the network node may estimate the downlink CSI based on uplink channel measurements of one or more sounding reference signals (SRSs) transmitted by the UE. However, using SRS measurements alone for downlink CSI determination may be limited by a lack of information about interference perceived by the UE or a UE receiver implementation, as well as by SRS periodicity or configuration restrictions. Accordingly, the downlink CSI determined by the network node using only SRS measurements may be less accurate than the downlink CSI determined by the UE.

Various aspects relate generally to channel covariance information. Some aspects more specifically relate to a network node providing channel covariance information to a UE. In some aspects, a network node may transmit, and a UE may receive, channel covariance information associated with a channel between the network node and the UE. The UE may transmit, to the network node, a CSI report based at least in part on the channel covariance information. In some examples, the channel covariance information may indicate a channel covariance matrix. In some examples, the channel covariance information may indicate a codeword index associated with a covariance matrix codebook or a scalar quantization of a subset of entries of a channel covariance matrix. In some examples, the channel covariance information may indicate a subspace associated with the channel covariance matrix or a set of eigenvectors associated with the channel covariance matrix. In some aspects, the channel covariance information may indicate one or more transmit modes of the network node or one or more receive modes of the UE. In such examples, the UE may determine and report CSI for multiple transmit modes for the network node or receive modes for the UE. In some aspects, the UE may report predicted CSI for a target time resource based on the channel covariance information.

Particular aspects of the subject matter described in this disclosure can be implemented to realize one or more of the following potential advantages. In some examples, by the UE receiving the channel covariance information from the network node, the described techniques can be used to enable the UE to acquire/estimate downlink CSI without calculating a channel covariance matrix or by leveraging the received channel covariance matrix. As a result, the CSI acquisition time and the computational burden of acquiring the CSI is reduced for the UE, which reduces processing resources, time resources, and power resources consumed by the UE for CSI acquisition. In some examples, by the UE receiving information associated with the channel covariance matrix and information indicating multiple transmit modes of the network node or multiple receive modes of the UE, the described techniques can be used to support mode adaptation for flexible network node or UE architectures, which may increase efficiency and reliability for downlink communications and reduce power consumption by the network node or the UE. In some examples, by using the channel covariance information to support channel prediction, the described techniques can enable additional flexibility in the acquisition and reporting of the CSI, resulting in decreased network latency and increased network throughput.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mm Wave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

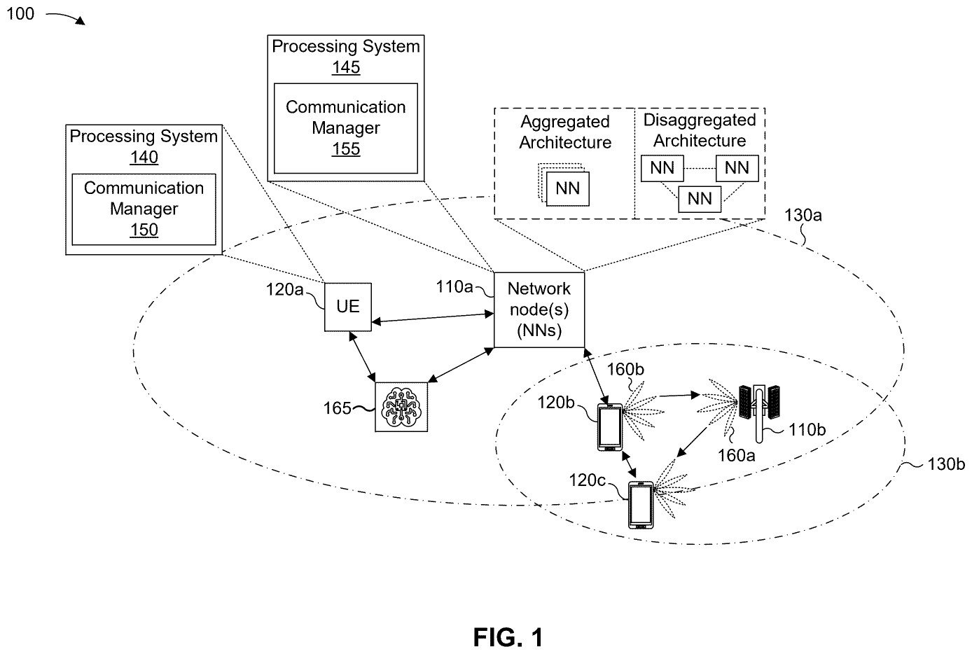

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FRI is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include an SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive channel covariance information associated with a channel between a network node and the UE; and transmit, to the network node, a CSI report based at least in part on the channel covariance information. Additionally, or alternatively, the communication manager 150 may perform one or more other operations described herein.

In some aspects, the network node 110 may include a communication manager 155. As described in more detail elsewhere herein, the communication manager 155 may transmit, to a UE, channel covariance information associated with a channel between the network node and the UE; and receive, from the UE, a CSI report based at least in part on the channel covariance information. Additionally, or alternatively, the communication manager 155 may perform one or more other operations described herein.

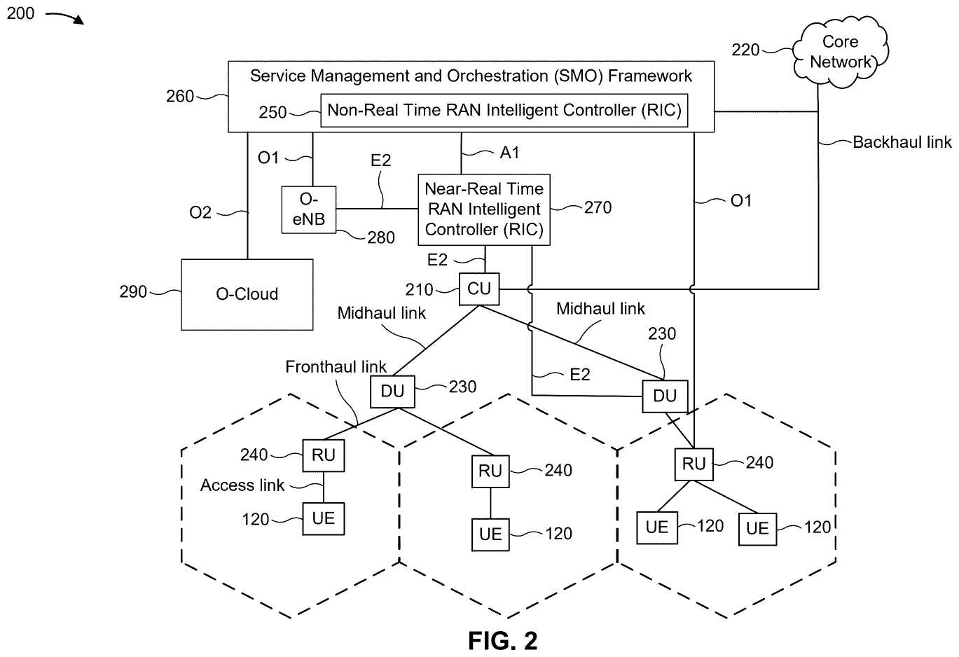

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUS 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

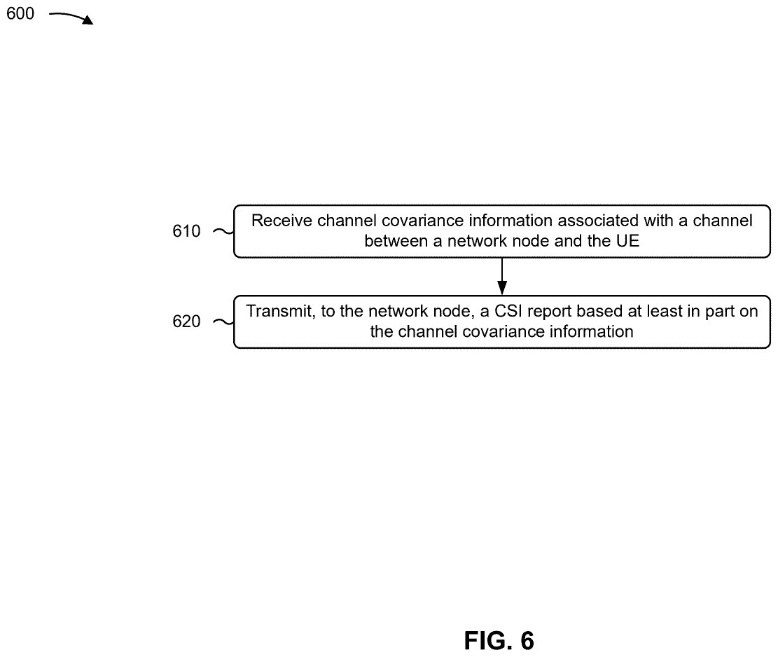

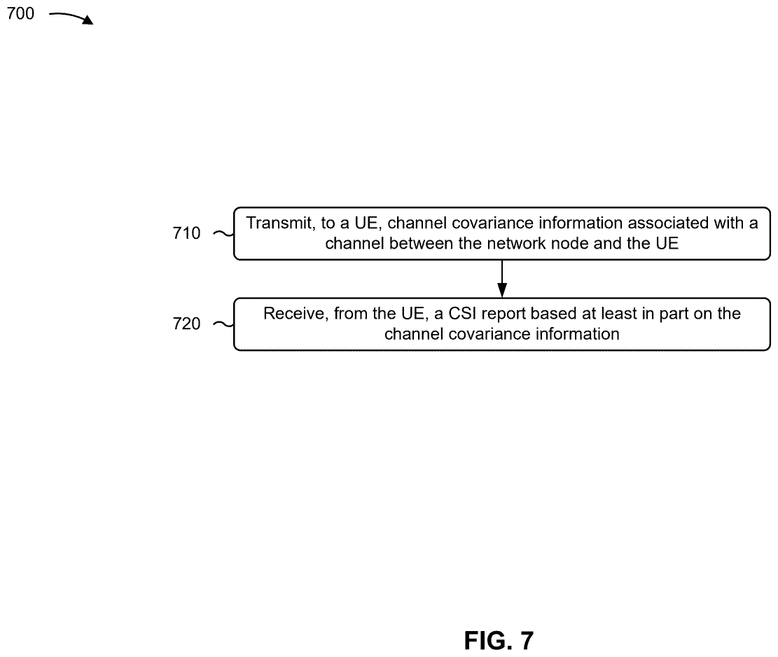

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with channel covariance information for mode adaptation, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

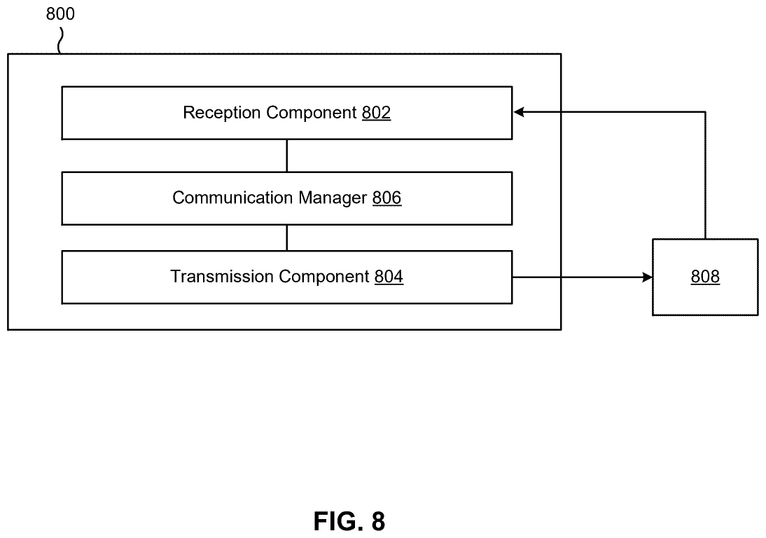

In some aspects, a UE (e.g., the UE 120) includes means for receiving channel covariance information associated with a channel between a network node and the UE; and/or means for transmitting, to the network node, a CSI report based at least in part on the channel covariance information. The means for the UE to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

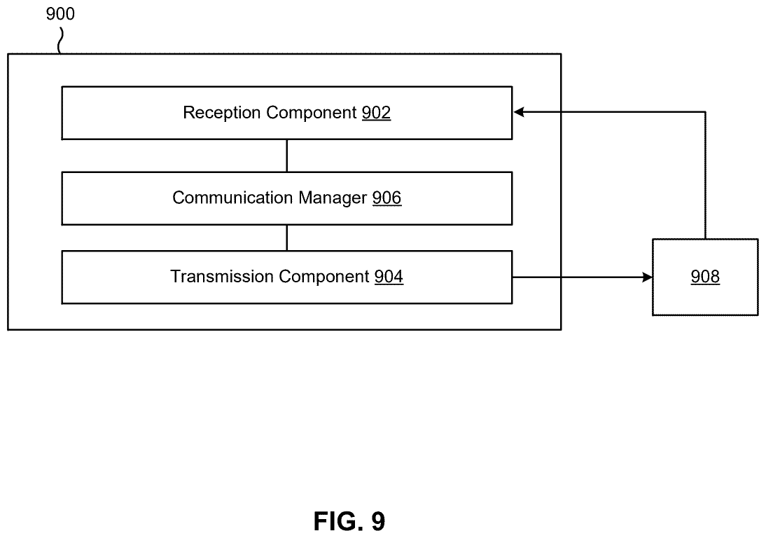

In some aspects, a network node (e.g., the network node 110) includes means for transmitting, to a UE, channel covariance information associated with a channel between the network node and the UE; and/or means for receiving, from the UE, a CSI report based at least in part on the channel covariance information. The means for the network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

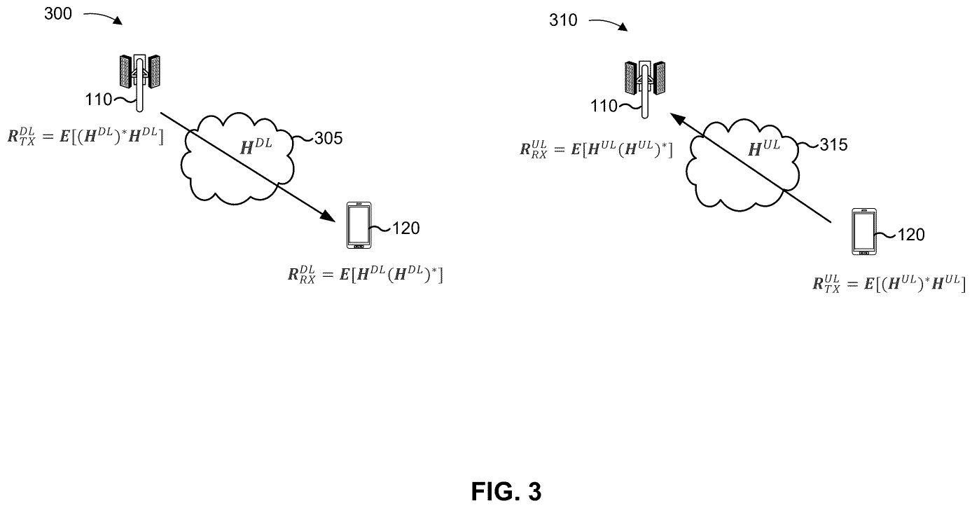

FIG. 3 is a diagram illustrating an example 300 of a downlink channel and an example 310 of an uplink channel. As shown in FIG. 3, examples 300 and 310 include a network node 110 and a UE 120.

As shown in example 300, the downlink channel between the network node 110 and the UE 120 may be seen (e.g., observed or measured) over the antennas of the UE 120 on a set of adjacent frequencies (e.g., a frequency band, such as FR3, among other examples). The downlink channel may be represented by a downlink channel matrix HDL, which characterizes the propagation of signals from the network node 110 to the UE 120 through a propagation environment 305. The propagation environment 305 may include one or more clusters of objects that affect the propagation of the signals from the network node 110 to the UE 120 (for example, by reflecting the signals), which may result in signals from the network node 110 propagating to the UE 120 on one or more paths through the propagation environment 305.

As shown in example 310, the uplink channel between the UE 120 and the network node 110 may be seen (e.g., observed or measured) over the antennas of the network node 110 on a set of adjacent frequencies (e.g., a frequency band, such as FR3, among other examples). The uplink channel may be represented by an uplink channel matrix HUL, which characterizes the propagation of signals from the UE 120 to the network node 110 through a propagation environment 315. The propagation environment 315 may include one or more clusters of objects that affect the propagation of the signals from the UE 120 to the network node 110 (for example, by reflecting the signals), which may result in signals from the UE 120 propagating to the network node 110 on one or more paths through the propagation environment 315.

In a case in which the downlink and uplink signals are transmitted on the same frequency band (e.g., in a TDD system), reciprocity between the downlink channel and the uplink channel holds, such that H^{UL}=(H^{DL})^{T}, where (H^{DL})^{T} denotes the transpose of H^{DL}. In all other cases, there is no such simple relationship between H^{UL} and H^{DL} due to uncorrelated/independent fast or short-term fading. As shown in example 300, downlink covariance matrices, including a downlink receive (Rx) covariance matrix

$$( {R}_{R X}^{D L} )$$

and a downlink transmit (Tx) covariance matrix

$$( {R}_{T X}^{D L} ) ,$$

may be defined as

$${R}_{R X}^{D L} = E [ {{H}^{D L} ( {H}^{D L} )}^{*} ] ,$$

where (H^{DL})* denotes the conjugate transpose of

$${H}^{D L} and {R}_{T X}^{D L} = E [ {( {H}^{D L} )}^{*} {H}^{D L} ] ,$$

where E denotes an expected value or expectation operator. As shown in example 310, uplink covariance matrices, including an uplink Rx covariance matrix

$$( {R}_{R X}^{U L} )$$

and an uplink Tx covariance matrix

$$( {R}_{T X}^{U L} ) ,$$

may be defined as

$${R}_{R X}^{U L} = E [ {{H}^{U L} ( {H}^{U L} )}^{*} ] and {R}_{T X}^{U L} = E [ {( {H}^{U L} )}^{*} {H}^{U L} ] .$$

In some examples, the UE 120 may use

$${R}_{R X}^{D L}$$

for hybrid-Rx beamforming for receiving downlink signals from the network node 110, and the UE 120 may use

$${R}_{TX}^{U L}$$

for hybrid-Tx beamforming for transmitting uplink signals to the network node 110. For example, the UE 120 may use

$${R}_{R X}^{D L}$$

to optimize analog combiners for hybrid-Rx beamforming, and the UE 120 may use

$${R}_{TX}^{U L}$$

to optimize analog precoders for hybrid-Tx beamforming. In some examples, network node 110 may use

$${R}_{T X}^{D L}$$

for hybrid-Tx beamforming for transmitting downlink signals to the UE 120, and the network node 110 may use

$${R}_{R X}^{U L}$$

for hybrid-Tx beamforming for receiving uplink signals from the UE 120. For example, the network node 110 may use

$${R}_{TX}^{D L}$$

to optimize analog precoders for hybrid-Tx beamforming, and the network node 110 may use

$${R}_{R X}^{U L}$$

to optimize analog combiners for hybrid-Rx beamforming.

A relationship (e.g., spatio-temporal congruence) between the channel covariance matrices

$$( {R}_{R X}^{D L} , {R}_{T X}^{D L} , {R}_{R X}^{U L} , {R}_{T X}^{U L} )$$

exists due to the common underlying structures, and this relationship can be exploited for covariance translation between downlink and uplink covariances (e.g., across frequency bands). In some aspects, the network node may provide (e.g., transmit) one or more of the channel covariance matrices, or information associated with one or more of the channel covariance matrices, to the UE 120 (e.g., as side information or assistance information). This channel covariance information may be used by the UE 120 for channel prediction (e.g., predicting the downlink channel at a future time resource), for reducing the CSI acquisition time and the computational burden associated with CSI acquisition, or for efficient mode adaptation for one or more Tx modes of the network node 110 or one or more Rx modes of the UE 120.

In some examples, while it is understood that the UE 120 generally determines the channel covariance and therefore, there is no reason for the network to indicate channel covariance information to the UE, in FR3, it may be challenging for the UE 120 to determine the channel covariance by itself without receiving channel covariance information from the network. This is because the underlying channel dimension may be large, while collecting sufficiently many samples to determine the channel covariance may be challenging due to limited connection times. For example, for a transmitter with up to 256 ports and a receiver with 8 ports, to collect 50 samples at a 20 ms reference signal (RS) periodicity takes 1 second, which as per-field data represents a very large connection time requirement. Accordingly, the network node 110 providing the UE 120 with the channel covariance information may be particularly advantageous in FR3.

As indicated above, FIG. 3 is provided as an example. Other examples may differ from what is described with respect to FIG. 3.

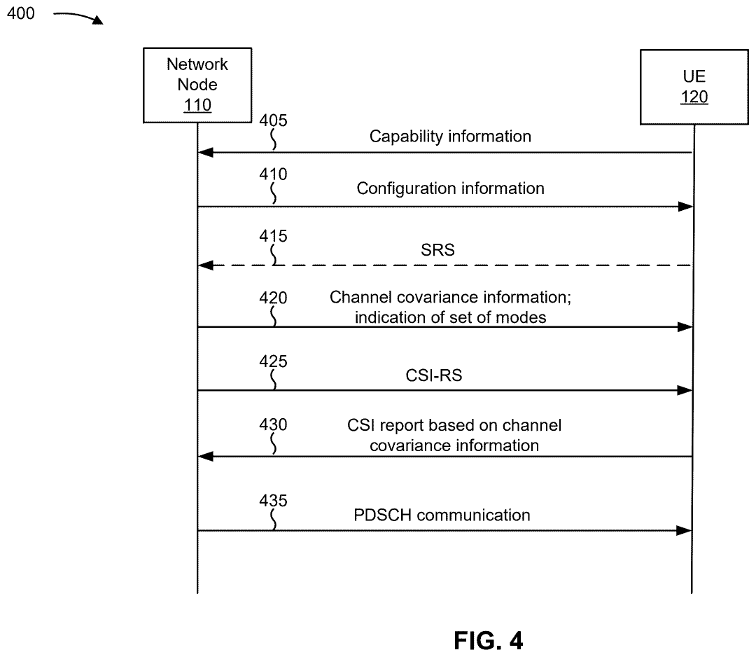

FIG. 4 is a diagram illustrating an example 400 associated with channel covariance information for mode adaptation, in accordance with the present disclosure. As shown in FIG. 4, example 400 includes communication between a network node 110 and a UE 120. In some aspects, the network node 110 and the UE 120 may be included in a wireless communication network, such as wireless communication network 100. The network node 110 and the UE 120 may communicate via a wireless access link, which may include an uplink and a downlink.

As shown in FIG. 4, and by reference number 405, the UE 120 may transmit, and the network node 110 may receive, capability information. The capability information may be included in a capability message or a capability report, for each as part of a capability exchange between the UE 120 and the network node 110. The UE 120 may transmit the capability information via RRC signaling, an uplink MAC-CE, or UCI, among other examples. The capability information may indicate one or more parameters associated with respective capabilities of the UE 120. The one or more parameters may be indicated via respective information elements (IEs) included in the capability message (or capability report).

In some aspects, the capability information may include information about an RF architecture of the UE 120. For example, the capability information may indicate mode information for one or more Rx modes for the UE 120. In some aspects, the mode information may indicate an analog beamforming (ABF) span for the UE 120. The ABF span is the maximum number of antenna elements with independent analog phase or amplitude control that an RF chain can be connected to. In some examples, the capability information may indicate mode information for multiple Rx modes for the UE 120. For example, multiple modes (e.g., Rx modes) with varying degrees of power saving may be defined for the UE 120. Different modes may have different numbers of activated RF chains (or digital ports). The mode information for each mode may identify a number of activated RF chains (or digital ports) used by the UE 120 in the mode, an ABF span per activated RF chain or a subset of antenna elements connected to each activated RF chain used in the mode, and one or more power related attributes of the mode, such as a total power, a power offset value, or a maximum power per RF chain, among other examples.

As further shown in FIG. 4, and by reference number 410, the network node 110 may transmit, and the UE 120 may receive, configuration information. In some aspects, the network node 110 may transmit the configuration information via one or more of system information signaling (e.g., a master information block (MIB) and/or a system information block (SIB), among other examples), RRC signaling, MAC signaling (e.g., one or more MAC-CEs), or DCI, among other examples.

In some aspects, the configuration information may include information about the RF architecture of the network node 110. For example, the configuration information may indicate mode information for one or more Tx modes for the network node 110. In some examples, the mode information may indicate an ABF span. In some examples, the configuration information may indicate mode information for multiple Tx modes for the network node 110. For example, multiple Tx modes with varying degrees of power saving may be defined for the network node 110. Different Tx modes may have different numbers of activated RF chains (or digital ports). The mode information for each Tx mode may identify a number of activated RF chains (or digital ports) used by the network node 110 in the Tx mode, an ABF span per activated RF chain or a subset of antenna elements connected to each activated RF chain used in the Tx mode, a total Tx power for the Tx mode, a maximum Tx power per RF chain in the Tx mode, a power offset value per RF chain used in the Tx mode, or one or more other Tx power related attributes of the Tx mode, among other examples. In some examples, the network node 110 may transmit (e.g., via RRC signaling) the configuration information indicating the mode information for the network node 110 as part of a capability exchange with the UE 120.

In some aspects, the configuration information may include an SRS configuration. The SRS configuration may configure transmission (e.g., periodic transmission) of an SRS by the UE 120. In some examples, the SRS configuration may be based at least in part on the ABF span indicated in the capability information received from the UE 120. The SRS configuration may configure the SRS transmission to have a different periodicity (e.g., a longer periodicity) from other reference signals described herein, such as the CSI-RSs, and from the CSI reporting described herein. In some aspects, the configuration information may include a CSI-RS configuration, a channel measurement resource (CMR) configuration (e.g., configuring a CSI-RS to be measured in the CMR), a CSI report configuration, or an interference measurement resource (IMR) configuration, among other examples.

As further shown in FIG. 4, and by reference number 415, in some aspects, the UE 120 may transmit, and the network node 110 may receive, an SRS. The UE 120 may transmit the SRS in accordance with the SRS configuration. In some examples, the SRS may be precoded. In some other examples, the SRS may not be precoded. In an example in which the UE 120 transmits a precoded SRS, the UE 120 may determine a noise-plus-interference covariance using a configured IMR, and the UE 120 may use the noise-plus-interference covariance as a whitening filter for the transmission of the precoded SRS. In some examples, the UE 120 may transmit the SRS with a longer periodicity (e.g., less frequently) than a periodicity at which the operations described below in connection with reference numbers 420, 425, and 430 are performed.

As further shown in FIG. 4, and by reference number 420, the network node 110 may transmit, and the UE 120 may receive, channel covariance information. The channel covariance information may indicate a channel covariance for a channel between the network node 110 and the UE 120, a subspace associated with the channel covariance, or other information related to the channel covariance. In some aspects, the network node 110 may transmit the channel covariance information in assistance information, RRC signaling, a MAC-CE, or DCI, among other examples. As further shown by reference number 420, the network node 110 may transmit, and the UE 120 may receive, an indication of a set of modes. In some examples, the indication of the set of modes may be included in the channel covariance information. For example, the channel covariance information may include information associated with a channel covariance and information indicating the set of modes. In some other examples, the indication of the set of modes may be transmitted in a separate transmission from the channel covariance information. In such examples, the indication of the set of modes may be transmitted via RRC signaling (e.g., layer 3 (L3) signaling), a MAC-CE (e.g. layer 2 (L2) signaling), or DCI (e.g., L1 signaling). In some aspects, the indication of the set of modes may indicate a set of Tx modes of the network node 110 for which the UE 120 is to compute/determine CSI metrics. In some examples, in addition to the set of Tx modes of the network node 110, the indication of the set of modes may also indicate a set of Rx modes of the UE 120 for which the UE 120 is to compute/determine CSI metrics.

In some aspects, the channel covariance information may indicate a channel covariance matrix for a channel between the network node 110 and the UE 120. The channel covariance matrix indicated by the channel covariance information may include at least one of the following matrix types: a full channel covariance matrix R=E[vec(H^{DL})(vec(H^{DL}))*], where vec(H^{DL}) denotes the column-wise vectorization operation applied on H^{DL}, an Rx-side channel covariance matrix R=E[H^{DL}(H^{DL})*] or a Tx-side channel covariance matrix R=E[(H^{DL})*H^{DL}]. For example, covariance may be defined over Tx digital ports and Rx physical antenna elements. Accordingly, a choice of Tx analog and possibly digital precoding may be included in the downlink channel matrix H^{DL}, and hence R. In some examples, a separate channel covariance matrix R may be determined by the network node 110 for each of such choices, and the network node 110 may indicate one or more of the channel covariance matrices determined by the network node 110 in the channel covariance information transmitted to the UE 120.

The network node 110 may provide information indicating or associated with at least one channel covariance matrix R in the channel covariance information transmitted to the UE 120. In some aspects, the network node 110 may determine the channel covariance matrix (e.g., an estimate for the channel covariance matrix) based on one or more of: one or more SRS transmissions received from the UE 120, one or more RSRP or signal-to-interference-plus-noise ratio (SINR) reports received from the UE 120, one or more location estimates of the UE 120, one or more CSI reports received from the UE 120, a digital twin network model, or one or more translation algorithms for translating a channel covariance matrix.

In some aspects, the channel covariance information may indicate the channel covariance matrix by indicating absolute values of diagonal entries of the channel covariance matrix, along with either: only one or more upper triangular complex-valued entries of the channel covariance matrix, or only one or more lower triangular complex-values entries of the channel covariance matrix. For example, the channel covariance information may indicate the absolute values of diagonal entries of the channel covariance matrix, along with only upper (or only lower) triangular complex-valued entries (magnitude/phase and position of each such entry) which are determined to be large enough (e.g., using any configured rule based on the diagonal entries). The Hermitian property of covariance ensures that only upper or only lower triangular entries need to be conveyed in addition to diagonal entries. These entries (e.g., the diagonal entries and only the selected upper triangular entries (or only the selected lower triangle entries)) may be quantized separately using a scalar quantization, and a scalar quantization of each of these entries may be indicated in the channel covariance information. The remaining entries of the channel covariance matrix may be set to zero.

In some other aspects, a channel covariance matrix codebook may be defined (e.g., via vector quantization), and the channel covariance information may indicate a codeword index associated with the channel covariance codebook. For example, the codeword index may map to a corresponding channel covariance matrix in the channel covariance matrix codebook. In such examples, the channel covariance codebook may be configured, for example, in configuration information transmitted to the UE 120 from the network node 110.

In some other aspects, the channel covariance matrix may be indicated to the UE 120 in the channel covariance information by a set of eigenvectors associated with the channel covariance matrix and associated (e.g., positive) eigenvalues. That is, the channel covariance information may indicate a set of eigenvectors associated with the channel covariance matrix and a respective set of eigenvalues (e.g., positive eigenvalues) associated with the set of eigenvectors. The set of eigenvectors forms a semi-unitary matrix describing a subspace. In some examples, the set of eigenvectors may be quantized and indicated by respective eigenvalues, with each eigenvalue being associated with a unique eigenvector.

In some aspects, the channel covariance information may indicate a respective channel covariance matrix for each of a plurality of frequency sub-bands. In this case, differential encoding may be used to reduce overhead. That is, the channel covariance information may indicate a first channel covariance matrix for a first sub-band (e.g., using any of the options described herein for indicating a channel covariance matrix), and the channel covariance matrix may indicate each of the other channel covariance matrices (e.g., for the other sub-bands) using an indication based on the differences between the first channel covariance matrix and the other channel covariance matrix. In some aspects, the network node 110 may determine a first channel covariance (e.g., a first channel covariance matrix) for a first frequency band (or sub-band) based on an SRS received in the first frequency band (or sub-band), translate the first channel covariance to a second channel covariance (e.g., a second channel covariance matrix) for a second frequency band (or sub-band), and indicate the second channel covariance information for the second frequency band (or sub-band) in the channel covariance information.

In some examples, the UE 120 may be directed, via a specific indication or configuration received from the network node 110, to use one or more indicated subsets of eigenvectors of an indicated (Tx-side) covariance matrix as the TX precoder hypotheses. In such examples, the UE 120 may determine and report only CQIs for each of these subsets (in the same order as the indicated subsets), thereby compressing/reducing CSI report overhead. In some examples, this can be implemented on a per-sub-band basis.

In some aspects, the channel covariance information may indicate a subspace associated with a channel covariance matrix. A subspace defined by the column-span of a semi-unitary matrix U (with unit-norm and mutually orthogonal columns) is referred to as dominant if the projection of a covariance matrix, R, onto the subspace defined by U contains at-least a fraction of a total energy of the covariance matrix, e.g., tr(U*RU)≥γ tr(R) for some fraction γ (e.g., γ=0.95). For example, R=E[H^{DL}(H^{DL})*] or R=E[(H^{DL})*H^{DL}] and R=UΛU* (eigen-decomposition). In some examples, the channel covariance information may indicate a dominant subspace associated with single user Tx precoding. For example, the dominant subspace may be conveyed/specified by indicating, in the channel covariance information, a set of vectors, where the subspace is implicitly indicated to be the span of those vectors. Such a dominant subspace may be suitable for single user MIMO (SU-MIMO). In some other examples, the channel covariance information may indicate a non-dominant subspace associated with interference aware transmit precoding. For example, the non-dominant subspace may facilitate interference aware multiple user precoding. In this case, the non-dominant subspace may be conveyed/specified in the channel covariance information similarly to as described above for the dominant subspace.

In examples in which a subspace (e.g., a dominant subspace or a non-dominant subspace) is indicated in the channel covariance information, the UE 120 may be further directed to assume that the Tx precoder (transmission hypothesis) will be restricted to the indicated subspace. In some examples, the set of vectors used to indicate a subspace in the channel covariance information may be a set of DFT vectors identified from a larger set of DFT vectors known to the UE 120 (e.g., configured for the UE 120). In some other examples, each vector in the set of vectors that identifies a subspace may be indicated in the channel covariance information by signaling a quantized phase and amplitude of each entry of that vector. In some other examples, the channel covariance information may indicate a parametrization of a semi-unitary matrix that defines a subspace. In such examples, the parametrization of the semi-unitary matrix (whose column span is the desired subspace) may be obtained by the network node 110 (e.g., via Givens rotation matrices or Householder matrices), and the network node 110 may indicate this parametrization in the channel covariance information (possibly after quantization of the parametrization). In some other examples, a codebook including a set of semi-unitary matrices may be pre-configured by the network node 110 (e.g., indicated in configuration information transmitted from the network node 110 to the UE 120), and the channel covariance information may indicate a codeword index that identifies a semi-unitary matrix, from a codebook of semi-unitary matrices, that defines the subspace. In some examples, a composite codebook including unitary matrices of different dimensions as codewords may be configured. A specific semi-unitary matrix may be indicated in the channel covariance information via an index first identifying the codeword unitary matrix from the composite codebook, and then selecting a subset of columns of that codeword unitary matrix.

In some examples, the channel covariance information may include one or more covariance or subspace indications (e.g., indicated using any of the options discussed herein). For example, the channel covariance information may include multiple covariance or subspace indications. In some aspects, for each covariance or subspace indication included in the channel covariance information, the channel covariance information may include a cell identifier (ID) associated with the covariance or subspace indication. Additionally, or alternatively, for each covariance or subspace indication included in the channel covariance information, the channel covariance information may include a UE ID associated with the covariance or subspace indication. Additionally, or alternatively, for each covariance or subspace indication included in the channel covariance information, the channel covariance information may include a respective TCI state associated with a QCL type D (QCL-D) source. In this case, the UE 120 may be further directed to use this TCI state as an Rx-precoder/combiner for both associated CMR and IMR, which enables the option of using the indicated covariance with a specific choice of combiner. Additionally, or alternatively, for each covariance or subspace indication included in the channel covariance information, the channel covariance information may include a set of frequencies, a set of component carriers, or a component carrier (e.g., an indication of a particular component carrier) associated with the covariance or subspace indication.

Additionally, or alternatively, for each covariance or subspace indication included in the channel covariance information, the channel covariance information may include a flag indicating whether the covariance or subspace indication is long-term or short-term. In a case in which the flag indicates that the covariance or subspace indication is short-term, the channel covariance may be averaged over a few channel snapshots or instantaneous channel snapshots, and the covariance may be more suitable for CSI computation overhead reduction. In a case in which the flag indicates that the covariance or subspace indication is long-term, the channel covariance may be averaged over several channel snapshots, and may be more suitable for prediction purposes (e.g., for predicting the channel or CSI for future time resources). In some examples, in a case in which the flag indicates that the covariance or subspace indication is long-term, the channel covariance information may further include one or more additional parameters. For example, the one or more additional parameters may include a time stamp or time offset (e.g., relative to an associated CMR) identifying one or more target time resources (e.g., a target slot or symbol) for channel prediction. Additionally, or alternatively, the one or more additional parameters may include one or more coefficients characterizing channel (e.g., cluster/path angles, delays, and potentially path gains) variability over time. Additionally, or alternatively, the one or more additional parameters may include an identifier associated with a prediction method (e.g., (extended) Kalman filter or Bayesian optimization, among other examples) for channel prediction and one or more parameters (e.g., hyper-parameters or coefficients) associated with the prediction method for channel prediction.

In some aspects, the channel covariance information may include information associated with a channel power-angle spectrum or power-angle-delay spectrum in the channel between the network node 110 and the UE 120. In some examples, the network node 110 may provide the information associated with the channel power-angle spectrum or the power-angle-delay spectrum in the channel covariance information in lieu of indicating a covariance matrix or a subspace. The information associated with the channel power-angle spectrum or the power-angle-delay spectrum may indicate a TCI state associated with a QCL-D source, and the information associated with the channel power-angle spectrum or the power-angle-delay spectrum may further indicate one or more of cluster angles associated with one or more clusters of objects, angle spreads associated with the one or more clusters of objects, relative cluster powers and delays associated with the one or more clusters of objects, or characteristic functions (e.g., truncated Laplacian, truncated Gaussian, uniform), among other examples.

In some aspects, the channel covariance information may include a flag (e.g., a persistent flag) that indicates whether the channel covariance information (e.g., the covariance matrix, subspace, or other information indicated in the channel covariance information) is to be used until updated channel covariance information is received. Additionally, or alternatively, the channel covariance information may include a validity timer that indicates a time duration associated with the channel covariance information. In this case, the UE 120 is only to use the channel covariance information until the validity time expires.

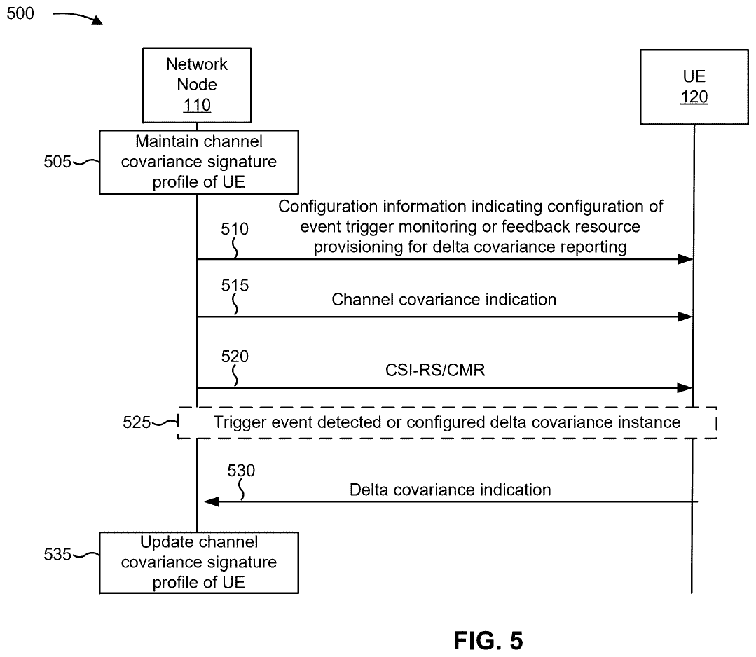

In some aspects, a channel covariance signature profile associated with the UE 120 may be maintained in the network (e.g., by the network node 110 or another network device), and the channel covariance information may include a channel covariance indication based on the channel covariance signature profile associated with the UE 120. For example, the channel covariance signature profile associated with the UE 120 may include one or more channel covariance matrices, and the channel covariance indication may correspond to a channel covariance matrix of the one or more channel covariance matrices included in the channel covariance signature profile associated with the UE 120. Such a channel covariance signature profile is described in greater detail in connection with FIG. 5.

In some aspects, the channel covariance information may include common covariance information for a group of UEs. In this case, the network node 110 may transmit the channel covariance information to a representative UE (e.g., the UE 120) in the group of UEs, and the representative UE (e.g., the UE 120) may transmit the channel covariance information (e.g., including the common covariance information for the group of UEs) to one or more other UEs in the group of UEs via sidelink communications. In such examples, the group of UEs may include multiple UEs that are experiencing common or similar propagation conditions for downlink signals transmitted by the network node 110.

As further shown in FIG. 4, and by reference number 425, the network node 110 may transmit, and the UE 120 may receive, a CSI-RS. The CSI-RS may be transmitted in a CMR configured for the UE 120. In some aspects, the UE 120 may process the CSI-RS (in the CMR) along with an associated IMR. In some aspects, the network node 110 may transmit the CSI-RS with one or more repetitions based at least in part on an ABF span (e.g., an ABF span of the network node 110 or the ABF span of the UE 120). In this case, the network node 110 may transmit multiple repetitions of the CSI-RS using different Tx modes of the network node 110 to enable the UE 120 to determine CSI for each of the different Tx modes of the network node 110. In some examples, the network node 110 may transmit multiple repetitions of the CSI-RS for each different Tx mode to enable the UE 120 to determine CSI using multiple Rx modes of the UE 120 for each Tx mode of the network node 110.

As further shown in FIG. 4, and by reference number 430, the UE 120 may transmit, and the network node 110 may receive, a CSI report based on the channel covariance information. In some aspects, the UE 120 may utilize the channel covariance information (e.g., the channel covariance matrix, the subspace, or other information indicated in the channel covariance information) to process the CMR (e.g., the CSI-RS). In some examples, the UE 120 may determine refined (and possibly compressed) CSI metrics by combining the CSI metrics with interference information measured on an associated IMR, for each Tx mode of the set of indicated Tx modes of the network node 110, and for one or more of the Rx modes of the UE 120. In some examples, the CSI metrics for a preferred Tx mode or a subset of Tx modes from the indicated set of Tx modes of the network node 110 may be reported in the CSI report.

In some aspects, the UE 120 may be configured to compute and/or report downlink CSI and metrics simultaneously for multiple Tx modes of the network node 110 based on a common CSI-RS resource set or CMR. A set of the Tx modes of the network node 110 may be configured or indicated (e.g., via L1, L2, or L3 signaling) by the network node 110. In some examples, a reference/default transmit mode (also used in absence of an indication of a set of modes) may be used to indicate that all L transmit digital ports in a configured CSI-RS resource set (e.g., indicated in configuration information received by the UE 120) will be used for subsequent (PDSCH) transmission by the network node 110. In some examples, all subsets of the L transmit digital ports with cardinality not exceeding (or not less than) some indicated value, M, may each be associated with a respective mode, and such subsets may thereby comprise the set of indicated Tx modes. In some other examples, pre-configured mapping can associate each of one or more Tx modes with pre-fixed subsets of the L transmit ports. The UE 120 can determine the CSI-RS power boost (or CSI-RS to PDSCH RE power ratio or scaling) values to be applied for each such Tx mode in determining the SINR and CQI metrics for the Tx mode. The Tx mode definitions conveyed to the UE 120 (e.g., in the configuration information) may indicate such power related attributes of the Tx modes.

In some aspects, the UE 120 may use the channel covariance information (e.g., when flagged as long-term) with an associated CMR (e.g., a CSI-RS) (and other parameters, if provided) to predict the downlink channel or downlink CSI for a target time resource (e.g., a target slot or symbol). In such examples, the UE 120 may use the predicted channel in the target slot or symbol (and the indicated covariance or subspace information) to determine one or more indicated metrics for the indicated set of Tx modes of the network node 110, and the UE 120 may include, in the CSI report, respective CSI and metrics for the target slot or symbol for each of the Tx modes. In some other examples, the UE 120 may be directed via an indication from the network node 110 (e.g., via L1, L2, or RRC signaling) to determine a preferred Tx mode or a preferred subset of Tx modes from the Tx modes in the indicated set of Tx modes. In this case, the cardinality of the preferred subset may be pre-configured or indicated. In such examples, the UE 120 may include in the CSI report the downlink CSI and metrics for the preferred Tx mode or preferred subset of Tx modes, as well as indices indicating the preferred Tx mode or the preferred subset of Tx modes.

In some aspects, the UE 120 may use the indicated channel covariance information (e.g., when flagged as short-term) along with the channel measured on an associated CMR (e.g., a CSI-RS) to compute/determine the downlink CSI and one or more metrics for each Tx mode in the indicated set of Tx modes. In some examples, the UE 120 may indicate, in the CSI report, the downlink CSI and metrics for each Tx mode in the indicated set of Tx modes. In some other examples, the UE 120 may be directed via an indication from the network node 110 (e.g., via L1, L2, or RRC signaling) to determine a preferred Tx mode or a preferred subset of Tx modes from the Tx modes in the indicated set of Tx modes. In this case, the UE 120 may include, in the CSI report, the downlink CSI and metrics for the preferred Tx mode or preferred subset of Tx modes, as well as indices indicating the preferred Tx mode or the preferred subset of Tx modes.

As further shown in FIG. 4, and by reference number 435, the network node 110 may transmit, and the UE 120 may receive, a PDSCH communication. The PDSCH communication may be based at least in part on the CSI report. For example, the network node 110 may transmit the PDSCH communication using a Tx mode selected based on the CSI report. Additionally, or alternatively, the network node 110 may adapt the transmission of the PDSCH communication to the current channel conditions based on the CSI report. In some aspects, the UE 120 may receive the PDSCH communication using an Rx mode selected based at least in part on the information included, by the UE 120, in the CSI report.

As indicated above, FIG. 4 is provided as an example. Other examples may differ from what is described with respect to FIG. 4.

FIG. 5 is a diagram illustrating an example 500 associated with channel covariance information for mode adaptation, in accordance with the present disclosure. As shown in FIG. 5, example 500 includes communication between a network node 110 and a UE 120. In some aspects, the network node 110 and the UE 120 may be included in a wireless communication network, such as wireless communication network 100. The network node 110 and the UE 120 may communicate via a wireless access link, which may include an uplink and a downlink.

As shown in FIG. 5 and by reference number 505, the network node 110 (or another network device) may maintain a channel covariance signature profile of the UE 120. Although the channel covariance signature profile of the UE 120 is described as being maintained by the network node 110 in the example of FIG. 5, the channel covariance signature profile may be stored on the network by one or more network devices other than the network node 110. The channel covariance signature profile of the UE 120 may depend on a location of the UE 120, a propagation environment (e.g., including one or more clusters) between the UE 120 and one or more network nodes (e.g., the network node 110 and/or one or more other network nodes or TRPs), and a frequency band. By maintaining the channel covariance signature profile of the UE 120, the network (e.g., the network node 110) may exploit spatial consistency or congruence when determining channel covariance information for the UE 120. This arises in part because the propagation channels between the UE 120 and some network nodes (e.g., the network node 110) may have one or more common clusters.

The channel covariance signature profile of the UE 120 may include multiple channel covariance matrices associated with the UE 120. In some aspects, the channel covariance signature profile of the UE 120 may include at least one downlink space-frequency covariance matrix for a TRP-UE channel. In some examples, the channel covariance signature profile of the UE 120 may include a downlink space-frequency covariance matrix for a TRP-UE channel that is determined at the UE 120, based on one or more CSI-RSs transmitted by the TRP, and reported back to the TRP. In some examples, the channel covariance signature profile of the UE 120 may include a downlink space-frequency covariance matrix for a TRP-UE channel that is determined at the TRP based on one or more SRSs transmitted by UE 120 via reciprocity or covariance translation. In some examples, the channel covariance signature profile of the UE 120 may include a respective downlink space-frequency covariance matrix for a TRP-UE channel for each of one or more frequency sets (e.g., with each frequency set including adjacent frequencies). In some examples, the channel covariance signature profile of the UE 120 may include a respective downlink space-frequency covariance matrix for a TRP-UE channel for each of one or more analog transmit precoder choices. In some examples, the channel covariance signature profile of the UE 120 may include a respective downlink space-frequency covariance matrix for a TRP-UE channel for each of one or more TRPs. In this case, the UE 120 may be provided with an RS spreading code or scrambling sequence of at least one neighbor cell.

In some aspects, the channel covariance signature profile of the UE 120 may include at least one uplink space-frequency covariance matrix for a UE-TRP channel. In some examples, the channel covariance signature profile of the UE 120 may include an uplink space-frequency covariance matrix for a UE-TRP channel determined at the TRP based on one or more SRSs transmitted by UE 120, possibly with covariance translation, by one or more TRPs. In some examples, the channel covariance signature profile of the UE 120 may include a respective uplink space-frequency covariance matrix for a UE-TRP channel for each of one or more frequency sets (e.g., with each frequency set including adjacent frequencies).

In some aspects, one or more channel covariance matrices included in the channel covariance signature profile of the UE 120 may be determined based on a digital twin network model used to emulate one or more TRP-UE channels. In some aspects, one or more covariance matrices determined for a TRP-UE channel may be translated to obtain covariance matrices for a second UE's TRP-UE channel, where the second UE experiences similar channel conditions or a similar propagation environment. In some examples, the similarity between the channel conditions or propagation-environment for the UEs may be assessed based on RSRPs corresponding to different SSB beams transmitted from a TRP and observed at each UE (e.g., for one or more TRPs, such as for a serving cell and one or more neighbor cells). In some other examples, the similarity between the channel conditions or propagation-environment for the UEs may be assessed based on RSRPs of RSs transmitted from each UE (e.g., for uplink beam training) and observed at a TRP (e.g., for one or more TRPs, where a TRP may be an uplink-only TRP). In some other examples, the similarity between the channel conditions or propagation-environment for the UEs may be assessed based on location estimates of the UEs.

In some aspects, maintaining the channel covariance signature profile of the UE 120 may include updating the channel covariance signature profile of the UE 120. In some aspects, the network node 110 (or another network device) may update the one or more of the covariance matrices in the channel covariance signature profile of the UE 120 based on CSI reports received from the UE 120 or SRS transmissions by the UE 120. In some other aspects, the UE 120 may be configured to compute and report a covariance matrix based on measurements over one or more associated CMRs.

As shown in FIG. 5, and by reference number 510, the network node 110 may transmit, and the UE 120 may receive, configuration information indicating a configuration of event trigger monitoring or feedback resource provision for delta covariance reporting. In some aspects, the configuration information configures the UE 120 to compute and report a covariance matrix based on measurements over one or more CMRs. In some examples, the configuration information may include a configuration of the CMRs to be measured by the UE 120. The configuration information may indicate a QCL-D assumption to be used by UE 120 for the computation of the covariance matrix. The configuration may indicate a type of covariance matrix for the UE 120 to compute. Additionally, or alternatively, a prior covariance matrix of a same type that is indicated by the network node 110 (e.g., in the channel covariance indication discussed in connection with reference number 515) may be used as a reference covariance matrix.

In some aspects, the configuration information may configure the UE 120 to perform periodic or semi-persistent reporting of covariance matrices computed by the UE 120. In this case, the configuration information provisions periodic or semi-persistent feedback resources (e.g., uplink resources) for reporting the covariance matrix. Each occurrence of the feedback resource corresponds to a configured reporting instance for reporting the covariance matrix. In some other aspects, the configuration information may configure the UE 120 to perform aperiodic reporting based on event trigger monitoring. In this case, the UE 120 may be configured to report the covariance in response to trigger event. In some examples, the trigger event may be configured for the UE 120. For example, the UE 120 may be configured to detect the trigger event based on a deviation between the channel predicted based on channel covariance information indicated by the network node 110 and the actual measured or observed channel satisfying (e.g., exceeding) a configured threshold. In some other examples, the trigger event may be detected by the network node 110.

In some aspects, the UE 120 may be configured to report the covariance matrix as a delta with respect to a reference covariance matrix (e.g., a most recent covariance matrix indicated by the network node 110).

As shown in FIG. 5, and by reference number 515, the network node 110 may transmit, and the UE 120 may receive, a channel covariance indication. The channel covariance indication may be an indication a channel covariance matrix (or multiple channel covariance matrices) based on the channel covariance signature profile of the UE 120 that is maintained by the network node 110 (or another network device). For example, the channel covariance indication may correspond to a channel covariance matrix included in the channel covariance signature profile of the UE 120. In some aspects, the channel covariance indication may be transmitted by the network node 110 via L1 signaling (e.g., DCI), L2 signaling (e.g., a MAC-CE), or L3 signaling (e.g., RRC signaling). In some examples, the channel covariance indication may be contingent upon a prior UE capability message indicating that the UE 120 is capable of utilizing such assistance.

In some aspects, the channel covariance indication that corresponds to a channel covariance matrix base on the channel covariance signature profile of the UE 120 may be an example of the channel covariance information described in connection with FIG. 4. In some aspects, the channel covariance matrix indicated by the channel covariance indication may be used by the UE 120 as a reference channel covariance matrix for reporting a channel covariance matrix computed by the UE 120.

As shown in FIG. 5, and by reference number 520, the network node 110 may transmit, and the UE 120 may receive, a CSI-RS (e.g., in a CMR). For example, the CSI-RS may be a CMR that the UE 120 is configured to use to compute a channel covariance matrix.

As shown in FIG. 5, and by reference number 525, a trigger event may be detected or a configured delta covariance reporting instance may occur. In an example in which the UE 120 is configured for delta covariance reporting based on event trigger monitoring, the trigger event for reporting the covariance may be detected. In some examples, the network node 110 may detect the trigger event. In such examples, the network node 110 may transmit, to the UE 120, a message requesting the UE 120 to report the delta covariance indication. In some examples the UE 120 may detect the trigger event. For example, the UE 120 may detect the trigger event in connection with determining that a deviation, between a channel predicted based on the reference channel covariance matrix indicated by the channel covariance indication received from the network node 110 and an actual measured or observed channel computed based on the CSI-RS, satisfies (e.g., exceeds) the configured threshold. In an example, in which the UE 120 is configured to periodically or semi-persistently report the delta covariance indication, the UE 120 may detect the occurrence of a configured delta covariance reporting instance.

As shown in FIG. 5, and by reference number 530, the UE 120 may transmit, and the network node 110 may receive, a delta covariance indication. In some aspects, the UE 120 may transmit the delta covariance indication in connection with the trigger event being detected (e.g., by the UE 120 or the network node 110). In some other aspects, the UE 120 may transmit the delta covariance indication in a configured instance for reporting the delta covariance indication (e.g., in a configured periodic or semi-persistent feedback resource for reporting the delta covariance indication). In some aspects, the delta covariance indication is based at least in part on differences between a channel covariance matrix determined/computed by the UE 120 and the reference covariance matrix indicated by the channel covariance indication received from the network node 110.

As shown in FIG. 5, and by reference number 535, the network node 110 may update the channel covariance signature profile of the UE 120 that is maintained on the network (e.g., by the network node 110 or another network device) based at least in part on the delta covariance indication received from the UE 120. One or more updated covariance matrices may also be used by the network node 110 to improve or refine its scheduling decisions such as to determine refined multi-user MIMO precoding. In some aspects, once the network node 110 updates the channel covariance signature profile of the UE 120, the network node 110 may transmit the updated channel covariance signature profile of the UE 120 to one or more other network nodes that may communicate with the UE 120. For example, the network node 110 may transmit the updated channel covariance signature profile of the UE 120 to one or more other network nodes via backhaul communications. In some examples, backhaul coordination (e.g., over Xn/F1 interfaces) may be performed between network nodes (e.g., between two associated DUs/CUs) in order to exchange updated parts of the covariance signature profile of the UE 120 that were updated at different times via communications with different network nodes.

As indicated above, FIG. 5 is provided as an example. Other examples may differ from what is described with respect to FIG. 5.

FIG. 6 is a diagram illustrating an example process 600 performed, for example, at a UE or an apparatus of a UE. Example process 600 is an example where the apparatus or the UE (e.g., UE 120) performs operations associated with channel covariance information for mode adaption.

As shown in FIG. 6, in some aspects, process 600 may include receiving channel covariance information associated with a channel between a network node and the UE (block 610). For example, the UE (e.g., using reception component 802 or communication manager 806, depicted in FIG. 8) may receive channel covariance information associated with a channel between a network node and the UE, as described above.

As further shown in FIG. 6, in some aspects, process 600 may include transmitting, to the network node, a CSI report based at least in part on the channel covariance information (block 620). For example, the UE (e.g., using transmission component 804 or communication manager 806, depicted in FIG. 8) may transmit, to the network node, a CSI report based at least in part on the channel covariance information, as described above.

Process 600 may include additional aspects, such as any single aspect or any combination of aspects described below or in connection with one or more other processes described elsewhere herein.

In a first aspect, the channel covariance information indicates a channel covariance matrix.

In a second aspect, alone or in combination with the first aspect, the channel covariance matrix is one of a full channel covariance matrix, a receive-side channel covariance matrix, or a transmit-side channel covariance matrix.

In a third aspect, alone or in combination with one or more of the first and second aspects, the channel covariance information indicates absolute values of diagonal entries of a channel covariance matrix, and either of one or more upper triangular complex-valued entries of the channel covariance matrix, or one or more lower triangular complex-valued entries of the channel covariance matrix.

In a fourth aspect, alone or in combination with one or more of the first through third aspects, the channel covariance information indicates a scalar quantization of each of the diagonal positive entries and the one or more upper triangular complex-valued entries of the channel covariance matrix or the one or more lower triangular complex-valued entries of the channel covariance matrix.

In a fifth aspect, alone or in combination with one or more of the first through fourth aspects, the channel covariance information indicates a codeword index associated with a channel covariance matrix codebook.

In a sixth aspect, alone or in combination with one or more of the first through fifth aspects, the channel covariance information indicates a set of eigenvectors associated with a covariance matrix and respective eigenvalues associated with the set of eigenvectors.

In a seventh aspect, alone or in combination with one or more of the first through sixth aspects, a subset of eigenvectors, of the set of eigenvectors, corresponds to a transmit precoder hypothesis, and the CSI report includes only a respective CQI for the subset of eigenvectors.

In an eighth aspect, alone or in combination with one or more of the first through seventh aspects, the channel covariance information indicates a respective channel covariance matrix for each of a plurality of frequency sub-bands.

In a ninth aspect, alone or in combination with one or more of the first through eighth aspects, the channel covariance information indicates a subspace associated with a channel covariance matrix.

In a tenth aspect, alone or in combination with one or more of the first through ninth aspects, the subspace is a dominant subspace associated with single user transmit precoding.

In an eleventh aspect, alone or in combination with one or more of the first through tenth aspects, the subspace is a non-dominant subspace associated with interference-aware transmit precoding.

In a twelfth aspect, alone or in combination with one or more of the first through eleventh aspects, the channel covariance information indicates a set of vectors that identifies the subspace.

In a thirteenth aspect, alone or in combination with one or more of the first through twelfth aspects, the channel covariance information indicates a parametrization of a semi-unitary matrix that defines the subspace.

In a fourteenth aspect, alone or in combination with one or more of the first through thirteenth aspects, the channel covariance information indicates a codeword index that identifies a semi-unitary matrix, from a codebook of semi-unitary matrices, that defines the subspace.

In a fifteenth aspect, alone or in combination with one or more of the first through fourteenth aspects, the channel covariance information includes one or more covariance indications and, for each covariance indication of the one or more covariance indications, the channel covariance information further includes at least one of a cell identifier associated with the covariance indication, a UE identifier associated with the covariance indication, a set of frequencies or component carriers associated with the covariance indication, or a flag indicating whether the covariance indication is long-term or short-term; or the channel covariance information includes one or more subspace indications and, for each subspace indication of the one or more subspace indications, the channel covariance information further includes at least one of a cell identifier associated with the subspace indication, a UE identifier associated with the subspace indication, a set of frequencies or component carriers associated with the subspace indication, a flag indicating whether the subspace indication is long-term or short-term.

In a sixteenth aspect, alone or in combination with one or more of the first through fifteenth aspects, the flag indicating whether the covariance indication is long-term or short-term indicates that the covariance indication is long term or the flag indicating whether the subspace indication is long-term or short-term indicates that the subspace indication is long term, and the channel covariance information further includes, for the covariance indication or the subspace indication, at least one of a time stamp or time offset identifying one or more target time resources for channel prediction, one or more coefficients characterizing channel variability over time, an identifier associated with a prediction method for channel prediction, or one or more parameters associated with the prediction method for channel prediction.

In a seventeenth aspect, alone or in combination with one or more of the first through sixteenth aspects, the flag indicating whether the covariance indication is long-term or short-term indicates that the covariance indication is long term or the flag indicating whether the subspace indication is long-term or short-term indicates that the subspace indication is long term, and the channel covariance information is based on a channel covariance that is averaged over multiple channel snapshots.

In an eighteenth aspect, alone or in combination with one or more of the first through seventeenth aspects, the channel covariance information includes information associated with a channel power-angle spectrum or power-angle-delay spectrum.

In a nineteenth aspect, alone or in combination with one or more of the first through eighteenth aspects, the information associated with the channel power-angle spectrum or power-angle-delay spectrum indicates a TCI state associated with a QCL-D source and at least one of clustering angles associated with one or more clusters of objects, angle spreads associated with the one or more clusters of objects, relative cluster powers and delays associated with the one or more clusters of objects, or one or more characteristic functions.

In a twentieth aspect, alone or in combination with one or more of the first through nineteenth aspects, the channel covariance information includes at least one of a flag indicating whether the channel covariance information is to be used until updated channel covariance information is received, or a validity timer indicating a time duration associated with the channel covariance information.

In a twenty-first aspect, alone or in combination with one or more of the first through twentieth aspects, receiving the channel covariance information includes receiving the channel covariance information from the network node.

In a twenty-second aspect, alone or in combination with one or more of the first through twenty-first aspects, the channel covariance information includes common covariance information for a group of UEs, and process 600 includes transmitting the common covariance information to one or more other UEs in the group of UEs.

In a twenty-third aspect, alone or in combination with one or more of the first through twenty-second aspects, receiving the channel covariance information includes receiving the channel covariance information from another UE.

In a twenty-fourth aspect, alone or in combination with one or more of the first through twenty-third aspects, the channel covariance information indicates a set of transmit modes associated with the network node, and the CSI report includes CSI for one or more transmit modes in the set of transmit modes.

In a twenty-fifth aspect, alone or in combination with one or more of the first through twenty-fourth aspects, process 600 includes receiving configuration information indicating a CSI-RS resource set, wherein the CSI-RS resource set indicates a set of transmit digital ports of the network node for transmission of CSI-RSs, and wherein each transmit mode, in the set of transmit modes, is associated with a respective subset of the set of transmit digital ports.

In a twenty-sixth aspect, alone or in combination with one or more of the first through twenty-fifth aspects, the CSI report includes CSI for each transmit mode in the set of transmit modes.

In a twenty-seventh aspect, alone or in combination with one or more of the first through twenty-sixth aspects, the CSI report includes an indication of one or more preferred transmit modes in the set of transmit modes, and CSI for the one or more preferred transmit modes in the set of transmit modes.

In a twenty-eighth aspect, alone or in combination with one or more of the first through twenty-seventh aspects, the channel covariance information indicates a set of receive modes associated with the UE, and the CSI report includes, for each of the one or transmit modes, CSI for one or more receive modes in the set of receive modes.

In a twenty-ninth aspect, alone or in combination with one or more of the first through twenty-eighth aspects, the CSI report includes CSI for a current channel based on the channel covariance information and a measurement of a CSI-RS.

In a thirtieth aspect, alone or in combination with one or more of the first through twenty-ninth aspects, the CSI report includes CSI for a predicted channel for a target time resource based on the channel covariance information and a measurement of a CSI-RS.

In a thirty-first aspect, alone or in combination with one or more of the first through thirtieth aspects, the channel covariance information indicates one or more channel covariance matrices from a covariance signature profile associated with the UE.

In a thirty-second aspect, alone or in combination with one or more of the first through thirty-first aspects, the covariance signature profile associated with the UE is based on at least one of one or more CSI reports transmitted by the UE, one or more SRSs transmitted by the UE, or a digital twin network model and one or more location estimates of the UE.

In a thirty-third aspect, alone or in combination with one or more of the first through thirty-second aspects, the channel covariance information indicates a first channel covariance matrix from the covariance signature profile associated with the UE, and process 600 includes determining a second channel covariance matrix based on channel measurements over one or more channel measurement resources, and transmitting, to the network node, an indication based at least in part on a difference between the second channel covariance matrix and the first channel covariance matrix.

In a thirty-fourth aspect, alone or in combination with one or more of the first through thirty-third aspects, the indication is a delta covariance indication based at least in part on the difference between the second channel covariance matrix and the first channel covariance matrix, and transmitting the indication includes transmitting the delta covariance indication in connection with detection of a trigger event.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with channel covariance information for mode adaption.

As shown in FIG. 7, in some aspects, process 700 may include transmitting, to a UE, channel covariance information associated with a channel between the network node and the UE (block 710). For example, the network node (e.g., using transmission component 904 or communication manager 906, depicted in FIG. 9) may transmit, to a UE, channel covariance information associated with a channel between the network node and the UE, as described above.

As further shown in FIG. 7, in some aspects, process 700 may include receiving, from the UE, a CSI report based at least in part on the channel covariance information (block 720). For example, the network node (e.g., using reception component 902 or communication manager 906, depicted in FIG. 9) may receive, from the UE, a CSI report based at least in part on the channel covariance information, as described above.

Process 700 may include additional aspects, such as any single aspect or any combination of aspects described below or in connection with one or more other processes described elsewhere herein.

In a first aspect, the channel covariance information indicates a channel covariance matrix.

In a second aspect, alone or in combination with the first aspect, the channel covariance matrix is one of a full channel covariance matrix, a receive-side channel covariance matrix, or a transmit-side channel covariance matrix.

In a third aspect, alone or in combination with one or more of the first and second aspects, the channel covariance information indicates absolute values of diagonal entries of a channel covariance matrix, and either of one or more upper triangular complex-valued entries of the channel covariance matrix, or one or more lower triangular complex-valued entries of the channel covariance matrix.

In a fourth aspect, alone or in combination with one or more of the first through third aspects, the channel covariance information indicates a scalar quantization of each of the diagonal positive entries and the one or more upper triangular complex-valued entries of the channel covariance matrix or the one or more lower triangular complex-valued entries of the channel covariance matrix.

In a fifth aspect, alone or in combination with one or more of the first through fourth aspects, the channel covariance information indicates a codeword index associated with a channel covariance matrix codebook.

In a sixth aspect, alone or in combination with one or more of the first through fifth aspects, the channel covariance information indicates a set of eigenvectors associated with a covariance matrix and respective eigenvalues associated with the set of eigenvectors.

In a seventh aspect, alone or in combination with one or more of the first through sixth aspects, a subset of eigenvectors, of the set of eigenvectors, corresponds to a transmit precoder hypothesis, and the CSI report includes only a respective CQI for the subset of eigenvectors.

In an eighth aspect, alone or in combination with one or more of the first through seventh aspects, the channel covariance information indicates a respective channel covariance matrix for each of a plurality of frequency sub-bands.

In a ninth aspect, alone or in combination with one or more of the first through eighth aspects, the channel covariance information indicates a subspace associated with a channel covariance matrix.

In a tenth aspect, alone or in combination with one or more of the first through ninth aspects, the subspace is a dominant subspace associated with single user transmit precoding.

In an eleventh aspect, alone or in combination with one or more of the first through tenth aspects, the subspace is a non-dominant subspace associated with interference-aware transmit precoding.

In a twelfth aspect, alone or in combination with one or more of the first through eleventh aspects, the channel covariance information indicates a set of vectors that identifies the subspace.

In a thirteenth aspect, alone or in combination with one or more of the first through twelfth aspects, the channel covariance information indicates a parametrization of a semi-unitary matrix that defines the subspace.

In a fourteenth aspect, alone or in combination with one or more of the first through thirteenth aspects, the channel covariance information indicates a codeword index that identifies a semi-unitary matrix, from a codebook of semi-unitary matrices, that defines the subspace.

In a fifteenth aspect, alone or in combination with one or more of the first through fourteenth aspects, the channel covariance information includes one or more covariance indications and, for each covariance indication of the one or more covariance indications, the channel covariance information further includes at least one of a cell identifier associated with the covariance indication, a UE identifier associated with the covariance indication, a set of frequencies or component carriers associated with the covariance indication, or a flag indicating whether the covariance indication is long-term or short-term; or the channel covariance information includes one or more subspace indications and, for each subspace indication of the one or more subspace indications, the channel covariance information further includes at least one of a cell identifier associated with the subspace indication, a UE identifier associated with the subspace indication, a set of frequencies or component carriers associated with the subspace indication, a flag indicating whether the subspace indication is long-term or short-term.

In a sixteenth aspect, alone or in combination with one or more of the first through fifteenth aspects, the flag indicating whether the covariance indication is long-term or short-term indicates that the covariance indication is long term or the flag indicating whether the subspace indication is long-term or short-term indicates that the subspace indication is long term, and the channel covariance information further includes, for the covariance indication or the subspace indication, at least one of a time stamp or time offset identifying one or more target time resources for channel prediction, one or more coefficients characterizing channel variability over time, an identifier associated with a prediction method for channel prediction, or one or more parameters associated with the prediction method for channel prediction.

In a seventeenth aspect, alone or in combination with one or more of the first through sixteenth aspects, the flag indicating whether the covariance indication is long-term or short-term indicates that the covariance indication is long term or the flag indicating whether the subspace indication is long-term or short-term indicates that the subspace indication is long term, and the channel covariance information is based on a channel covariance that is averaged over multiple channel snapshots.

In an eighteenth aspect, alone or in combination with one or more of the first through seventeenth aspects, the channel covariance information includes information associated with a channel power-angle spectrum or power-angle-delay spectrum.

In a nineteenth aspect, alone or in combination with one or more of the first through eighteenth aspects, the information associated with the channel power-angle spectrum or power-angle-delay spectrum indicates a TCI state associated with a QCL-D source and at least one of clustering angles associated with one or more clusters of objects, angle spreads associated with the one or more clusters of objects, relative cluster powers and delays associated with the one or more clusters of objects, or one or more characteristic functions.

In a twentieth aspect, alone or in combination with one or more of the first through nineteenth aspects, the channel covariance information includes at least one of a flag indicating whether the channel covariance information is to be used until updated channel covariance information is received, or a validity timer indicating a time duration associated with the channel covariance information.

In a twenty-first aspect, alone or in combination with one or more of the first through twentieth aspects, the channel covariance information includes common covariance information for a group of UEs, and the UE is a representative UE in the group of UEs.

In a twenty-second aspect, alone or in combination with one or more of the first through twenty-first aspects, the channel covariance information indicates a set of transmit modes associated with the network node, and the CSI report includes CSI for one or more transmit modes in the set of transmit modes.

In a twenty-third aspect, alone or in combination with one or more of the first through twenty-second aspects, process 700 includes transmitting, to the UE, configuration information indicating a CSI-RS resource set, wherein the CSI-RS resource set indicates a set of transmit digital ports of the network node for transmission of CSI-RSs, and wherein each transmit mode, in the set of transmit modes, is associated with a respective subset of the set of transmit digital ports.

In a twenty-fourth aspect, alone or in combination with one or more of the first through twenty-third aspects, the CSI report includes CSI for each transmit mode in the set of transmit modes.

In a twenty-fifth aspect, alone or in combination with one or more of the first through twenty-fourth aspects, the CSI report includes an indication of one or more preferred transmit modes in the set of transmit modes, and CSI for the one or more preferred transmit modes in the set of transmit modes.

In a twenty-sixth aspect, alone or in combination with one or more of the first through twenty-fifth aspects, the channel covariance information indicates a set of receive modes associated with the UE, and the CSI report includes, for each of the one or transmit modes, CSI for one or more receive modes in the set of receive modes.

In a twenty-seventh aspect, alone or in combination with one or more of the first through twenty-sixth aspects, the CSI report includes CSI for a current channel based on the channel covariance information and a measurement of a CSI-RS.

In a twenty-eighth aspect, alone or in combination with one or more of the first through twenty-seventh aspects, the CSI report includes CSI for a predicted channel for a target time resource based on the channel covariance information and a measurement of a CSI-RS.

In a twenty-ninth aspect, alone or in combination with one or more of the first through twenty-eighth aspects, the channel covariance information indicates one or more channel covariance matrices from a covariance signature profile associated with the UE.

In a thirtieth aspect, alone or in combination with one or more of the first through twenty-ninth aspects, process 700 includes maintaining the covariance signature profile associated with the UE.

In a thirty-first aspect, alone or in combination with one or more of the first through thirtieth aspects, the covariance signature profile associated with the UE is based on at least one of one or more CSI reports transmitted by the UE, one or more SRSs transmitted by the UE, or a digital twin network model and one or more location estimates of the UE.

In a thirty-second aspect, alone or in combination with one or more of the first through thirty-first aspects, the channel covariance information indicates a first channel covariance matrix from the covariance signature profile associated with the UE, and process 700 includes receiving, from the UE, an indication based at least in part on a difference between the second channel covariance matrix and the first channel covariance matrix, and updating the covariance signature profile based on the indication received from the UE.

In a thirty-third aspect, alone or in combination with one or more of the first through thirty-second aspects, the indication is a delta covariance indication based at least in part on the difference between the second channel covariance matrix and the first channel covariance matrix, and receiving the indication includes receiving the delta covariance indication in connection with detection of a trigger event.

In a thirty-fourth aspect, alone or in combination with one or more of the first through thirty-third aspects, process 700 includes determining a first channel covariance associated with a first frequency band based at least in part on an SRS in the first frequency band, and translating the first channel covariance to a second channel covariance associated with a second frequency band, wherein the channel covariance information indicates the second channel covariance.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 3-5. Additionally, or alternatively, the apparatus 800 may be configured to perform one or more processes described herein, such as process 600 of FIG. 6, or a combination thereof. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive channel covariance information associated with a channel between a network node and the UE. The transmission component 804 may transmit, to the network node, a CSI report based at least in part on the channel covariance information.

The reception component 802 may receive configuration information indicating a CSI-RS resource set, wherein the CSI-RS resource set indicates a set of transmit digital ports of the network node for transmission of CSI-RSs, and wherein each transmit mode, in the set of transmit modes, is associated with a respective subset of the set of transmit digital ports.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 3-5. Additionally, or alternatively, the apparatus 900 may be configured to perform one or more processes described herein, such as process 700 of FIG. 7, or a combination thereof. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit, to a UE, channel covariance information associated with a channel between the network node and the UE. The reception component 902 may receive, from the UE, a CSI report based at least in part on the channel covariance information.

The transmission component 904 may transmit, to the UE, configuration information indicating a CSI-RS resource set, wherein the CSI-RS resource set indicates a set of transmit digital ports of the network node for transmission of CSI-RSs, and wherein each transmit mode, in the set of transmit modes, is associated with a respective subset of the set of transmit digital ports.

The communication manager 906 may maintain the covariance signature profile associated with the UE.

The communication manager 906 may determine a first channel covariance associated with a first frequency band based at least in part on an SRS in the first frequency band.

The communication manager 906 may translate the first channel covariance to a second channel covariance associated with a second frequency band, wherein the channel covariance information indicates the second channel covariance.

The number and arrangement of components shown in FIG. 9 are provided as an example. In practice, there may be additional components, fewer components, different components, or differently arranged components than those shown in FIG. 9.

Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: receiving channel covariance information associated with a channel between a network node and the UE; and transmitting, to the network node, a channel state information (CSI) report based at least in part on the channel covariance information.
Aspect 2: The method of Aspect 1, wherein the channel covariance information indicates a channel covariance matrix.
Aspect 3: The method of Aspect 2, wherein the channel covariance matrix is one of a full channel covariance matrix, a receive-side channel covariance matrix, or a transmit-side channel covariance matrix.
Aspect 4: The method of any of Aspects 1-3, wherein the channel covariance information indicates: absolute values of diagonal entries of a channel covariance matrix, and either of: one or more upper triangular complex-valued entries of the channel covariance matrix, or one or more lower triangular complex-valued entries of the channel covariance matrix.
Aspect 5: The method of Aspect 4, wherein the channel covariance information indicates a scalar quantization of each of the diagonal positive entries and the one or more upper triangular complex-valued entries of the channel covariance matrix or the one or more lower triangular complex-valued entries of the channel covariance matrix.
Aspect 6: The method of any of Aspects 1-3, wherein the channel covariance information indicates a codeword index associated with a channel covariance matrix codebook.
Aspect 7: The method of any of Aspects 1-3, wherein the channel covariance information indicates a set of eigenvectors associated with a covariance matrix and respective eigenvalues associated with the set of eigenvectors.
Aspect 8: The method of Aspect 7, wherein a subset of eigenvectors, of the set of eigenvectors, corresponds to a transmit precoder hypothesis, and wherein the CSI report includes only a respective channel quality indicator (CQI) for the subset of eigenvectors.
Aspect 9: The method of any of Aspects 1-8, wherein the channel covariance information indicates a respective channel covariance matrix for each of a plurality of frequency sub-bands.
Aspect 10: The method of any of Aspects 1-3, wherein the channel covariance information indicates a subspace associated with a channel covariance matrix.
Aspect 11: The method of Aspect 10, wherein the subspace is a dominant subspace associated with single user transmit precoding.
Aspect 12: The method of Aspect 10, wherein the subspace is a non-dominant subspace associated with interference-aware transmit precoding.
Aspect 13: The method of any of Aspects 10-12, wherein the channel covariance information indicates a set of vectors that identifies the subspace.
Aspect 14: The method of any of Aspects Aspect 10-12, wherein the channel covariance information indicates a parametrization of a semi-unitary matrix that defines the subspace.
Aspect 15: The method of Aspect 10, wherein the channel covariance information indicates a codeword index that identifies a semi-unitary matrix, from a codebook of semi-unitary matrices, that defines the subspace.
Aspect 16: The method of any of Aspects 1-15, wherein the channel covariance information includes one or more covariance indications and, for each covariance indication of the one or more covariance indications, the channel covariance information further includes at least one of: a cell identifier associated with the covariance indication, a UE identifier associated with the covariance indication, a set of frequencies or component carriers associated with the covariance indication, or a flag indicating whether the covariance indication is long-term or short-term; wherein the channel covariance information includes one or more subspace indications and, for each subspace indication of the one or more subspace indications, the channel covariance information further includes at least one of: a cell identifier associated with the subspace indication, a UE identifier associated with the subspace indication, a set of frequencies or component carriers associated with the subspace indication, a flag indicating whether the subspace indication is long-term or short-term.
Aspect 17: The method of Aspect 16, wherein the flag indicating whether the covariance indication is long-term or short-term indicates that the covariance indication is long term or wherein the flag indicating whether the subspace indication is long-term or short-term indicates that the subspace indication is long term; and wherein the channel covariance information further includes, for the covariance indication or the subspace indication, at least one of: a time stamp or time offset identifying one or more target time resources for channel prediction, one or more coefficients characterizing channel variability over time, an identifier associated with a prediction method for channel prediction, or one or more parameters associated with the prediction method for channel prediction.
Aspect 18: The method of any of Aspects 16-17, wherein the flag indicating whether the covariance indication is long-term or short-term indicates that the covariance indication is long term or the flag indicating whether the subspace indication is long-term or short-term indicates that the subspace indication is long term; and wherein the channel covariance information is based on a channel covariance that is averaged over multiple channel snapshots.
Aspect 19: The method of any of Aspects 1-18, wherein the channel covariance information includes information associated with a channel power-angle spectrum or power-angle-delay spectrum.
Aspect 20: The method of Aspect 19, wherein the information associated with the channel power-angle spectrum or power-angle-delay spectrum indicates a transmission configuration indication (TCI) state associated with a quasi co-location (QCL) type D (QCL-D) source and at least one of: cluster angles associated with one or more clusters of objects, angle spreads associated with the one or more clusters of objects, relative cluster powers and delays associated with the one or more clusters of objects, or one or more characteristic functions.
Aspect 21: The method of any of Aspects 1-20, wherein the channel covariance information includes at least one of: a flag indicating whether the channel covariance information is to be used until updated channel covariance information is received, or a validity timer indicating a time duration associated with the channel covariance information.
Aspect 22: The method of any of Aspects 1-21, wherein receiving the channel covariance information comprises: receiving the channel covariance information from the network node.
Aspect 23: The method of Aspect 22, wherein the channel covariance information includes common covariance information for a group of UEs, and further comprising: transmitting the common covariance information to one or more other UEs in the group of UEs.
Aspect 24: The method of any of Aspects 1-23, wherein receiving the channel covariance information comprises: receiving the channel covariance information from another UE.
Aspect 25: The method of any of Aspects 1-24, wherein the channel covariance information indicates a set of transmit modes associated with the network node, and wherein the CSI report includes CSI for one or more transmit modes in the set of transmit modes.
Aspect 26: The method of Aspect 25, further comprising: receiving configuration information indicating a CSI reference signal (CSI-RS) resource set, wherein the CSI-RS resource set indicates a set of transmit digital ports of the network node for transmission of CSI-RSs, and wherein each transmit mode, in the set of transmit modes, is associated with a respective subset of the set of transmit digital ports.
Aspect 27: The method of Aspect 25, wherein the CSI report includes CSI for each transmit mode in the set of transmit modes.
Aspect 28: The method of Aspect 25, wherein the CSI report includes: an indication of one or more preferred transmit modes in the set of transmit modes, and CSI for the one or more preferred transmit modes in the set of transmit modes.
Aspect 29: The method of Aspect 25, wherein the channel covariance information indicates a set of receive modes associated with the UE, and wherein the CSI report includes, for each of the one or transmit modes, CSI for one or more receive modes in the set of receive modes.
Aspect 30: The method of any of Aspects 1-29, wherein the CSI report includes CSI for a current channel based on the channel covariance information and a measurement of a CSI reference signal (CSI-RS).
Aspect 31: The method of any of Aspects 1-30, wherein the CSI report includes CSI for a predicted channel for a target time resource based on the channel covariance information and a measurement of a CSI reference signal (CSI-RS).
Aspect 32: The method of any of Aspects 1-31, wherein the channel covariance information indicates one or more channel covariance matrices from a covariance signature profile associated with the UE.
Aspect 33: The method of Aspect 32, wherein the covariance signature profile associated with the UE is based on at least one of: one or more CSI reports transmitted by the UE, one or more sounding reference signals (SRSs) transmitted by the UE, or a digital twin network model and one or more location estimates of the UE.
Aspect 34: The method of any of Aspects 32-33, wherein the channel covariance information indicates a first channel covariance matrix from the covariance signature profile associated with the UE, and further comprising: determining a second channel covariance matrix based on channel measurements over one or more channel measurement resources; and transmitting, to the network node, an indication based at least in part on a difference between the second channel covariance matrix and the first channel covariance matrix.
Aspect 35: The method of Aspect 34, wherein the indication is a delta covariance indication based at least in part on the difference between the second channel covariance matrix and the first channel covariance matrix; and wherein transmitting the indication comprises transmitting the delta covariance indication in connection with detection of a trigger event.
Aspect 36: A method of wireless communication performed by a network node, comprising: transmitting, to a user equipment (UE), channel covariance information associated with a channel between the network node and the UE; and receiving, from the UE, a channel state information (CSI) report based at least in part on the channel covariance information.
Aspect 37: The method of Aspect 36, wherein the channel covariance information indicates a channel covariance matrix.
Aspect 38: The method of Aspect 37, wherein the channel covariance matrix is one of a full channel covariance matrix, a receive-side channel covariance matrix, or a transmit-side channel covariance matrix.
Aspect 39: The method of any of Aspects 36-38, wherein the channel covariance information indicates: absolute values of diagonal entries of a channel covariance matrix, and either of: one or more upper triangular complex-valued entries of the channel covariance matrix, or one or more lower triangular complex-valued entries of the channel covariance matrix.
Aspect 40: The method of Aspect 39, wherein the channel covariance information indicates a scalar quantization of each of the diagonal positive entries and the one or more upper triangular complex-valued entries of the channel covariance matrix or the one or more lower triangular complex-valued entries of the channel covariance matrix.
Aspect 41: The method of any of Aspects 36-40, wherein the channel covariance information indicates a codeword index associated with a channel covariance matrix codebook.
Aspect 42: The method of any of Aspects 36-41, wherein the channel covariance information indicates a set of eigenvectors associated with a covariance matrix and respective eigenvalues associated with the set of eigenvectors.
Aspect 43: The method of Aspect 42, wherein a subset of eigenvectors, of the set of eigenvectors, corresponds to a transmit precoder hypothesis, and wherein the CSI report includes only a respective channel quality indicator (CQI) for the subset of eigenvectors.
Aspect 44: The method of any of Aspects 36-43, wherein the channel covariance information indicates a respective channel covariance matrix for each of a plurality of frequency sub-bands.
Aspect 45: The method of any of Aspects 36-44, wherein the channel covariance information indicates a subspace associated with a channel covariance matrix.
Aspect 46: The method of Aspect 45, wherein the subspace is a dominant subspace associated with single user transmit precoding.
Aspect 47: The method of Aspect 45, wherein the subspace is a non-dominant subspace associated with interference-aware transmit precoding.
Aspect 48: The method of any of Aspects 45-47, wherein the channel covariance information indicates a set of vectors that identifies the subspace.
Aspect 49: The method of any of Aspects 45-47, wherein the channel covariance information indicates a parametrization of a semi-unitary matrix that defines the subspace.
Aspect 50: The method of any of Aspects 45-47, wherein the channel covariance information indicates a codeword index that identifies a semi-unitary matrix, from a codebook of semi-unitary matrices, that defines the subspace.
Aspect 51: The method of any of Aspects 36-50, wherein the channel covariance information includes one or more covariance indications and, for each covariance indication of the one or more covariance indications, the channel covariance information further includes at least one of: a cell identifier associated with the covariance indication, a UE identifier associated with the covariance indication, a set of frequencies or component carriers associated with the covariance indication, or a flag indicating whether the covariance indication is long-term or short-term; wherein the channel covariance information includes one or more subspace indications and, for each subspace indication of the one or more subspace indications, the channel covariance information further includes at least one of: a cell identifier associated with the subspace indication, a UE identifier associated with the subspace indication, a set of frequencies or component carriers associated with the subspace indication, a flag indicating whether the subspace indication is long-term or short-term.
Aspect 52: The method of Aspect 51, wherein the flag indicating whether the covariance indication is long-term or short-term indicates that the covariance indication is long term or wherein the flag indicating whether the subspace indication is long-term or short-term indicates that the subspace indication is long term; and wherein the channel covariance information further includes, for the covariance indication or the subspace indication, at least one of: a time stamp or time offset identifying one or more target time resources for channel prediction, one or more coefficients characterizing channel variability over time, an identifier associated with a prediction method for channel prediction, or one or more parameters associated with the prediction method for channel prediction.
Aspect 53: The method of any of Aspects 51-52, wherein the flag indicating whether the covariance indication is long-term or short-term indicates that the covariance indication is long term or the flag indicating whether the subspace indication is long-term or short-term indicates that the subspace indication is long term; and wherein the channel covariance information is based on a channel covariance that is averaged over multiple channel snapshots.
Aspect 54: The method of any of Aspects 36-53, wherein the channel covariance information includes information associated with a channel power-angle spectrum or power-angle-delay spectrum.
Aspect 55: The method of Aspect 54, wherein the information associated with the channel power-angle spectrum or power-angle-delay spectrum indicates a transmission configuration indication (TCI) state associated with a quasi co-location (QCL) type D (QCL-D) source and at least one of: cluster angles associated with one or more clusters of objects, angle spreads associated with the one or more clusters of objects, relative cluster powers and delays associated with the one or more clusters of objects, or one or more characteristic functions.
Aspect 56: The method of any of Aspects 36-55, wherein the channel covariance information includes at least one of: a flag indicating whether the channel covariance information is to be used until updated channel covariance information is received, or a validity timer indicating a time duration associated with the channel covariance information.
Aspect 57: The method of any of Aspects 36-56, wherein the channel covariance information includes common covariance information for a group of UEs, and wherein the UE is a representative UE in the group of UEs.
Aspect 58: The method of any of Aspects 36-57, wherein the channel covariance information indicates a set of transmit modes associated with the network node, and wherein the CSI report includes CSI for one or more transmit modes in the set of transmit modes.
Aspect 59: The method of Aspect 58, further comprising: transmitting, to the UE, configuration information indicating a CSI reference signal (CSI-RS) resource set, wherein the CSI-RS resource set indicates a set of transmit digital ports of the network node for transmission of CSI-RSs, and wherein each transmit mode, in the set of transmit modes, is associated with a respective subset of the set of transmit digital ports.
Aspect 60: The method of Aspect 58, wherein the CSI report includes CSI for each transmit mode in the set of transmit modes.
Aspect 61: The method of Aspect 58, wherein the CSI report includes: an indication of one or more preferred transmit modes in the set of transmit modes, and CSI for the one or more preferred transmit modes in the set of transmit modes.
Aspect 62: The method of Aspect 58, wherein the channel covariance information indicates a set of receive modes associated with the UE, and wherein the CSI report includes, for each of the one or transmit modes, CSI for one or more receive modes in the set of receive modes.
Aspect 63: The method of any of Aspects 36-62, wherein the CSI report includes CSI for a current channel based on the channel covariance information and a measurement of a CSI reference signal (CSI-RS).
Aspect 64: The method of any of Aspects 36-63, wherein the CSI report includes CSI for a predicted channel for a target time resource based on the channel covariance information and a measurement of a CSI reference signal (CSI-RS).
Aspect 65: The method of any of Aspects 36-64, wherein the channel covariance information indicates one or more channel covariance matrices from a covariance signature profile associated with the UE.
Aspect 66: The method of Aspect 65, further comprising: maintaining the covariance signature profile associated with the UE.
Aspect 67: The method of any of Aspects 65-66, wherein the covariance signature profile associated with the UE is based on at least one of: one or more CSI reports transmitted by the UE, one or more sounding reference signals (SRSs) transmitted by the UE, or a digital twin network model and one or more location estimates of the UE.
Aspect 68: The method of any of Aspects 65-67, wherein the channel covariance information indicates a first channel covariance matrix from the covariance signature profile associated with the UE, and further comprising: receiving, from the UE, an indication based at least in part on a difference between the second channel covariance matrix and the first channel covariance matrix; and updating the covariance signature profile based on the indication received from the UE.
Aspect 69: The method of Aspect 70, wherein the indication is a delta covariance indication based at least in part on the difference between the second channel covariance matrix and the first channel covariance matrix; and wherein receiving the indication comprises receiving the delta covariance indication in connection with detection of a trigger event.
Aspect 70: The method of any of Aspects 36-69, further comprising: determining a first channel covariance associated with a first frequency band based at least in part on an SRS in the first frequency band; and translating the first channel covariance to a second channel covariance associated with a second frequency band, wherein the channel covariance information indicates the second channel covariance.
Aspect 71: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-70.
Aspect 72: An apparatus for wireless communication at a device, the apparatus comprising one or more memories and one or more processors coupled to the one or more memories, the one or more processors configured to cause the device to perform the method of one or more of Aspects 1-70.
Aspect 73: An apparatus for wireless communication, the apparatus comprising at least one means for performing the method of one or more of Aspects 1-70.
Aspect 74: A non-transitory computer-readable medium storing code for wireless communication, the code comprising instructions executable by one or more processors to perform the method of one or more of Aspects 1-70.
Aspect 75: A non-transitory computer-readable medium storing a set of instructions for wireless communication, the set of instructions comprising one or more instructions that, when executed by one or more processors of a device, cause the device to perform the method of one or more of Aspects 1-70.
Aspect 76: A device for wireless communication, the device comprising a processing system that includes one or more processors and one or more memories coupled with the one or more processors, the processing system configured to cause the device to perform the method of one or more of Aspects 1-70.
Aspect 77: An apparatus for wireless communication at a device, the apparatus comprising one or more memories and one or more processors coupled to the one or more memories, the one or more processors individually or collectively configured to cause the device to perform the method of one or more of Aspects 1-70.
Aspect 78: A device comprising a processing system that includes one or more processors and one or more code-storing memories coupled with the one or more processors, the processing system configured to cause the device to perform the method of one or more of Aspects 1-70.
Aspect 79: A device comprising a processing system that includes processor circuitry and code-storing memory circuitry, the processing system configured to cause the device to perform the method of one or more of Aspects 1-70.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a transceiver, and
a processing system that includes one or more processors and one or more code-storing memories coupled with the one or more processors, the processing system configured to:
receive, via the transceiver, channel covariance information associated with a channel between a network node and the UE; and
transmit, to the network node via the transceiver, a channel state information (CSI) report based at least in part on the channel covariance information.

2. The UE of claim 1, wherein the channel covariance information indicates a channel covariance matrix, and wherein the channel covariance matrix is one of a full channel covariance matrix, a receive-side channel covariance matrix, or a transmit-side channel covariance matrix.

3. The UE of claim 1, wherein the channel covariance information indicates:
absolute values of diagonal entries of a channel covariance matrix, and either of:
one or more upper triangular complex-valued entries of the channel covariance matrix, or
one or more lower triangular complex-valued entries of the channel covariance matrix.

4. The UE of claim 1, wherein the channel covariance information indicates:
a codeword index associated with a channel covariance matrix codebook, or
a set of eigenvectors associated with a covariance matrix and respective eigenvalues associated with the set of eigenvectors.

5. The UE of claim 1, wherein the channel covariance information indicates a respective channel covariance matrix for each of a plurality of frequency sub-bands.

6. The UE of claim 1, wherein the channel covariance information indicates a subspace associated with a channel covariance matrix.

7. The UE of claim 6, wherein the subspace is a dominant subspace associated with single user transmit precoding, or the subspace is a non-dominant subspace associated with interference-aware transmit precoding.

8. The UE of claim 6, wherein the channel covariance information indicates:
a set of vectors that identifies the subspace,
a parametrization of a semi-unitary matrix that defines the subspace, or
a codeword index that identifies the semi-unitary matrix, from a codebook of semi-unitary matrices, that defines the subspace.

9. The UE of claim 1, wherein the channel covariance information includes one or more covariance indications and, for each covariance indication of the one or more covariance indications, the channel covariance information further includes at least one of:
a cell identifier associated with the covariance indication,
a UE identifier associated with the covariance indication,
a set of frequencies or component carriers associated with the covariance indication, or
a flag indicating whether the covariance indication is long-term or short-term; or
wherein the channel covariance information includes one or more subspace indications and, for each subspace indication of the one or more subspace indications, the channel covariance information further includes at least one of:
a cell identifier associated with the subspace indication,
a UE identifier associated with the subspace indication,
a set of frequencies or component carriers associated with the subspace indication, or
a flag indicating whether the subspace indication is long-term or short-term.

10. The UE of claim 9, wherein the flag indicating whether the covariance indication is long-term or short-term indicates that the covariance indication is long term or wherein the flag indicating whether the subspace indication is long-term or short-term indicates that the subspace indication is long term; and
wherein the channel covariance information further includes, for the covariance indication or the subspace indication, at least one of:
a time stamp or time offset identifying one or more target time resources for channel prediction,
one or more coefficients characterizing channel variability over time,
an identifier associated with a prediction method for channel prediction, or
one or more parameters associated with the prediction method for channel prediction.

11. The UE of claim 1, wherein the channel covariance information includes information associated with a channel power-angle spectrum or power-angle-delay spectrum, and wherein the information associated with the channel power-angle spectrum or power-angle-delay spectrum indicates a transmission configuration indication (TCI) state associated with a quasi co-location (QCL) type D (QCL-D) source and at least one of:
cluster angles associated with one or more clusters of objects,
angle spreads associated with the one or more clusters of objects,
relative cluster powers and delays associated with the one or more clusters of objects, or
one or more characteristic functions.

12. The UE of claim 1, wherein the channel covariance information includes at least one of:
a flag indicating whether the channel covariance information is to be used until updated channel covariance information is received, or
a validity timer indicating a time duration associated with the channel covariance information.

13. The UE of claim 1, wherein the channel covariance information indicates a set of transmit modes associated with the network node, and wherein the CSI report includes CSI for one or more transmit modes in the set of transmit modes.

14. The UE of claim 1, wherein the CSI report includes CSI for a predicted channel for a target time resource based on the channel covariance information and a measurement of a CSI reference signal (CSI-RS).

15. The UE of claim 1, wherein the channel covariance information indicates one or more channel covariance matrices from a covariance signature profile associated with the UE.

16. The UE of claim 15, wherein the channel covariance information indicates a first channel covariance matrix from the covariance signature profile associated with the UE, and wherein the processing system is configured to:
determine a second channel covariance matrix based on channel measurements over one or more channel measurement resources; and
transmit, to the network node, an indication based at least in part on a difference between the second channel covariance matrix and the first channel covariance matrix.

17. A network node for wireless communication, comprising:
a transceiver; and
a processing system that includes one or more processors and one or more code-storing memories coupled with the one or more processors, the processing system configured to:
transmit, to a user equipment (UE) via the transceiver, channel covariance information associated with a channel between the network node and the UE; and
receive, from the UE via the transceiver, a channel state information (CSI) report based at least in part on the channel covariance information.

18. A method of wireless communication performed by a user equipment (UE), comprising:
receiving channel covariance information associated with a channel between a network node and the UE; and
transmitting, to the network node, a channel state information (CSI) report based at least in part on the channel covariance information.

19. The method of claim 18, wherein the channel covariance information indicates a subspace associated with a channel covariance matrix.

20. The method of claim 19, wherein the subspace is a dominant subspace associated with single user transmit precoding, or the subspace is a non-dominant subspace associated with interference-aware transmit precoding.
